(19) United States
(12) Patent Application Publication
(10) Pub. No.: US 2026/0301235 A1
(43) Pub. Date: Oct. 1, 2026

(54) METHODS FOR NEURAL NETWORK-BASED INTRA PREDICTION

(71) Applicant: Alibaba (China) Co., Ltd., Hangzhou, Zhejiang (CN)

(72) Inventors: Zixiang ZHANG, Beijing (CN); Jie CHEN, Beijing (CN); Xinwei LI, Beijing (CN); Ru-ling LIAO, Sunnyvale, CA (US); Yan YE, San Diego, CA (US)

(21) Appl. No.: 19/555,598

(22) Filed: Mar. 3, 2026

Related U.S. Application Data
(60) Provisional application No. 63/777,851, filed on Mar. 26, 2025.

(51) Int. Cl. G06T 9/00; H04N 19/176; H04N 19/593

(52) U.S. Cl. CPC G06T 9/002; H04N 19/176; H04N 19/593

(57) ABSTRACT

The present disclosure provides a computer-implemented method for video processing. The method includes receiving a video sequence; and encoding the video sequence by: determining a block size of a block; determining whether the block size is included in a first list; in response to the block size is not included in the first list, determining whether the block size is included in a second list; in response to the block size is included in the second list, selecting a neural network model for the block size and performing downsampling on the block based on the block size and the neural network model; and performing a neural network-based intra prediction (NNIP) on the block using the neural network model.

### CROSS-REFERENCE TO RELATED APPLICATIONS

This disclosure claims the benefits of priority to U.S. Provisional Application No. 63/777,851, filed on Mar. 26, 2025, which is incorporated herein by reference in its entirety.

### TECHNICAL FIELD

The present disclosure generally relates to video processing, and more particularly, to methods for neural network-based intra prediction.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for encoding a video sequence. The method includes receiving a video sequence; and encoding the video sequence by: determining a block size of a block; determining whether the block size is included in a first list; in response to the block size is not included in the first list, determining whether the block size is included in a second list; in response to the block size is included in the second list, selecting a neural network model for the block size and performing downsampling on the block based on the block size and the neural network model; and performing a neural network-based intra prediction (NNIP) on the block using the neural network model.

Embodiments of the present disclosure provide a method for decoding a bitstream. The decoding includes receiving a bitstream; and decoding the bitstream to generate a video sequence. The decoding includes determining a block size of a block; determining whether the block size is included in a first list; in response to the block size is not included in the first list, determining whether the block size is included in a second list; in response to the block size is included in the second list, selecting a neural network model for the block size and performing downsampling on the block based on the block size and the neural network model; and performing a neural network-based intra prediction (NNIP) on the block using the neural network model.

Embodiments of the present disclosure provide a method for signaling a bitstream, the method includes receiving a video sequence; encoding the video sequence by: determining a block size of a block; determining whether the block size is included in a first list; in response to the block size is not included in the first list, determining whether the block size is included in a second list; in response to the block size is included in the second list, selecting a neural network model for the block size and performing downsampling on the block based on the block size and the neural network model; and performing a neural network-based intra prediction (NNIP) on the block using the neural network model; and signaling a bitstream that is generated based on the encoding.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 illustrates exemplary reference samples used in planar mode, according to some embodiments of the present disclosure.

FIG. 6 illustrates angular intra prediction modes in the VVC standard, according to some embodiments of the present disclosure.

FIG. 7 illustrates Adjacent blocks (L, A, BL, AR, AL) used in the derivation of a general most probable mode (MPM) list, according to some embodiments of the present disclosure.

FIG. 8 illustrates exemplary L shaped neighborhood for a given predicted block, according to some embodiments of the present disclosure.

FIG. 9 illustrates exemplary edge operator options, according to some embodiments of the present disclosure.

FIG. 10 illustrates exemplary non-adjacent spatial neighboring blocks that are used in occurrence-based intra coding (OBIC) mode's histogram generation, according to some embodiments of the present disclosure.

FIG. 11 illustrates exemplary spatial geometric partition mode (SGPM). candidates, according to some embodiments of the present disclosure.

FIG. 12 illustrates an exemplary geometric partition mode (GPM) template, according to some embodiments of the present disclosure.

FIG. 13 illustrates an exemplary GPM blending, according to some embodiments of the present disclosure.

FIG. 14 illustrates an exemplary network architecture, according to some embodiments of the present disclosure.

FIG. 15 illustrates an exemplary N reference samples to predict a given W×H luma CB, according to some embodiments of the present disclosure.

FIG. 16 shows an exemplary framework illustrating sequential matrix multiplications and LeakyReLUs (piecewise-linear functions), according to some embodiments of the present disclosure.

FIG. 17 shows another exemplary framework illustrating sequential matrix multiplications and LeakyReLUs (piecewise-linear functions), according to some embodiments of the present disclosure.

FIG. 18 shows another exemplary framework illustrating sequential matrix multiplications and LeakyReLUs (piecewise-linear functions), according to some embodiments of the present disclosure.

FIG. 19 illustrates examples of the GPM splits grouped by identical angles, according to some embodiments.

FIG. 20A illustrates a parallel mode for GPM with inter and intra prediction, according to some embodiments of the present disclosure.

FIG. 20B illustrates a perpendicular mode for GPM with inter and intra prediction, according to some embodiments of the present disclosure.

FIG. 20C illustrates a planar mode for GPM with inter and intra prediction, according to some embodiments of the present disclosure

FIG. 20D illustrates another example of GPM with intra and intra prediction, according to some embodiments of the present disclosure.

FIG. 21 illustrates top and left neighboring blocks used in combined inter and intra prediction (CIP) weight derivation, according to some embodiments of the present disclosure.

FIG. 22A illustrates an exemplary division method for angular mode, according to some embodiments of the present disclosure.

FIG. 22B illustrates another exemplary division method for angular mode, according to some embodiments of the present disclosure.

FIG. 23 is a flowchart of an exemplary method for extending the neural network-based intra prediction (NNIP) mode, according to some embodiments of the present disclosure.

FIG. 24 is a flowchart of an exemplary method for fusing an NNIP mode with other modes, according to some embodiments of the present disclosure.

FIG. 25 is a flowchart of an exemplary method for extending NNIP to other prediction modes, according to some embodiments of the present disclosure.

FIG. 26 illustrates exemplary template prediction for NNIP mode, according to some embodiments of the present disclosure.

FIG. 27 illustrates exemplary template prediction of NNIP using approximate method, according to some embodiments of the present disclosure.

FIG. 28 is a flowchart of an exemplary method for determining an angular-wise weight for a CIP mode, according to some embodiments of the present disclosure.

FIG. 29 illustrates exemplary three categories for block with width/height equals to 2, according to some embodiments of the present disclosure.

FIG. 30 illustrates exemplary angle between two angle modes for a pixel, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently, and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

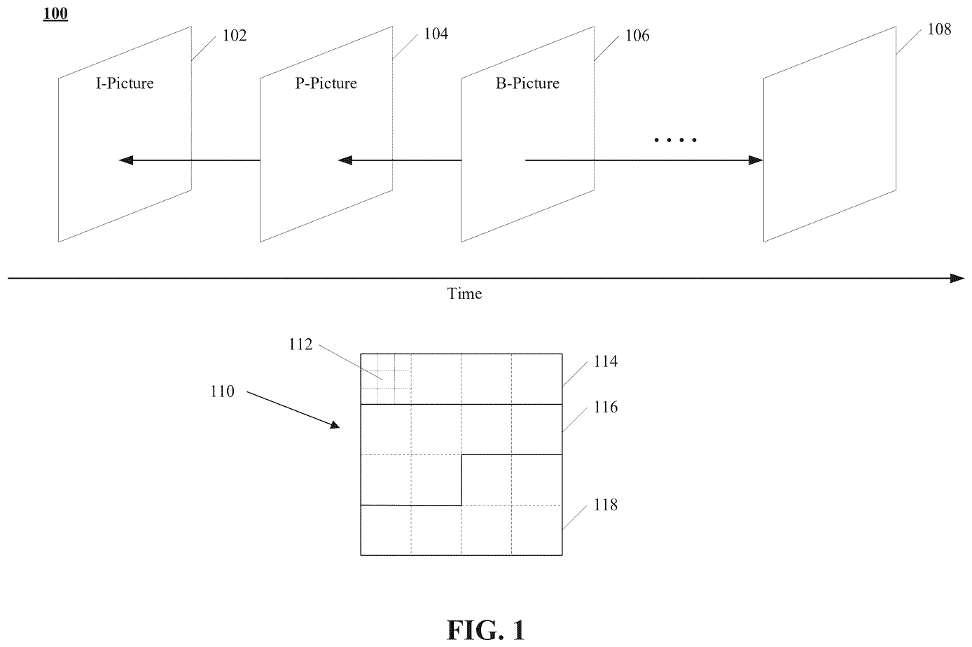

FIG. 1 illustrates structures of an exemplary video sequence 100, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

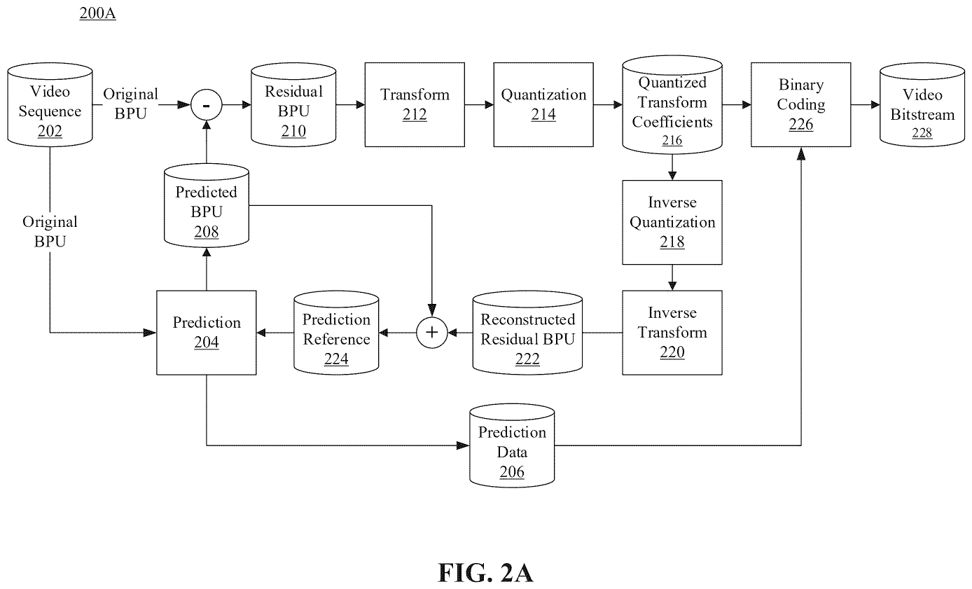

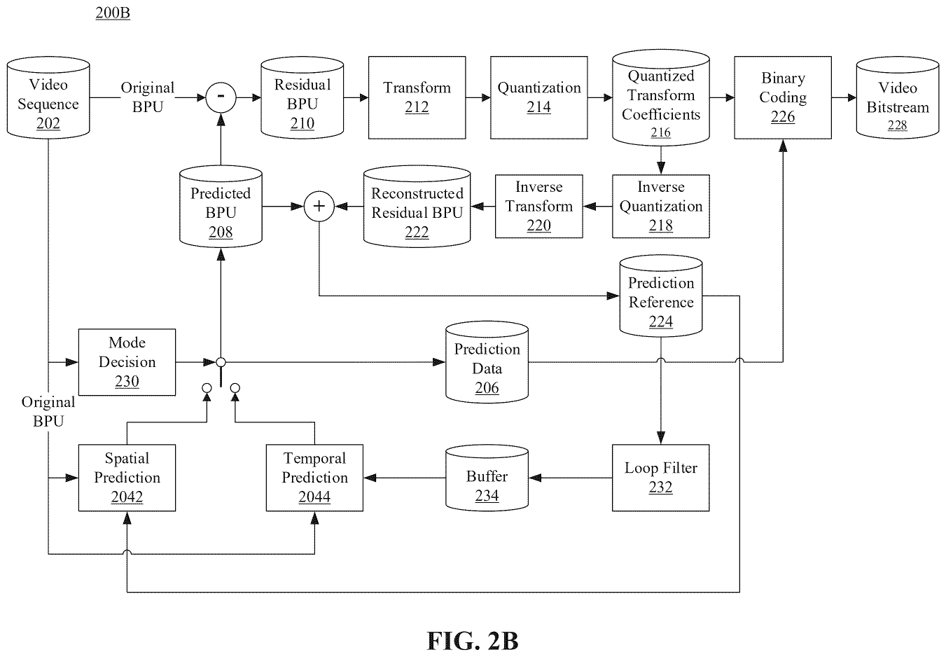

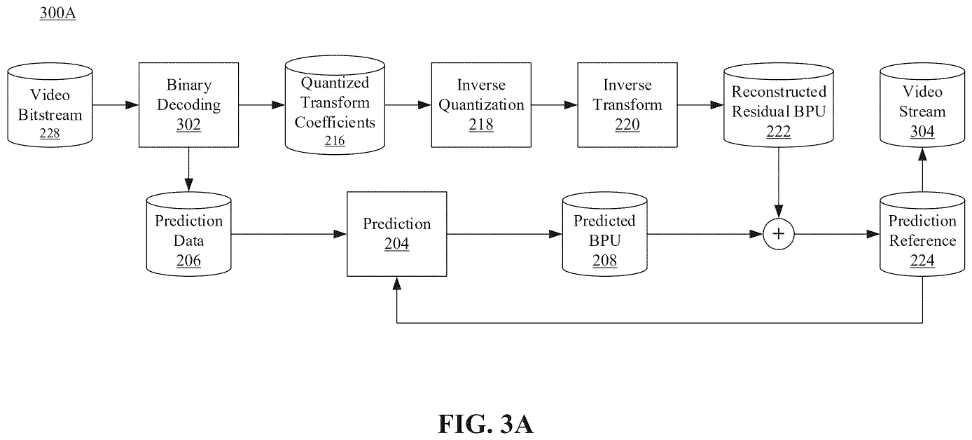

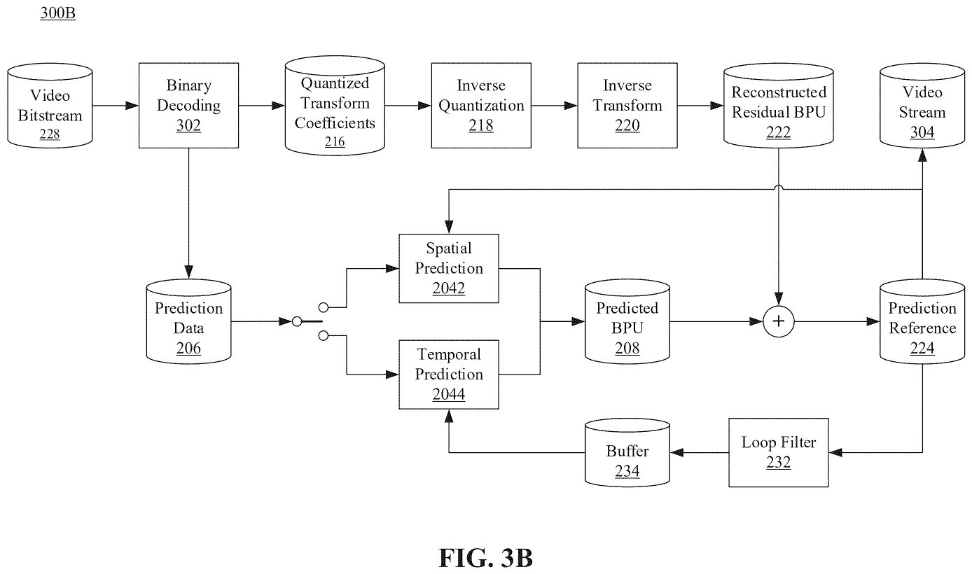

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIG. 2A and FIG. 2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an exemplary encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization syntax element or any other syntax element of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, syntax elements of the prediction operation, a transform type at transform stage 212, syntax elements of the quantization process (e.g., quantization syntax elements), an encoder control syntax element (e.g., a bitrate control syntax element), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, syntax elements of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer (DPB)”) for later use (e.g., to be used as an inter-prediction reference picture for a future picture of video sequence 202). The encoder can store one or more reference pictures in buffer 234 to be used at temporal prediction stage 2044. In some embodiments, the encoder can encode syntax elements of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIG. 2A and FIG. 2B), generally, video stream 304 is not identical to video sequence 202. Similar to processes 200A and 200B in FIG. 2A and FIG. 2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, syntax elements of the prediction operation, a transform type, syntax elements of the quantization process (e.g., quantization syntax elements), an encoder control syntax element (e.g., a bitrate control syntax element), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, syntax elements of the intra prediction operation, or the like. The syntax elements of the intra prediction operation can include, for example, locations (e.g., coordinates) of one or more neighboring BPUs used as a reference, sizes of the neighboring BPUs, syntax elements of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, syntax elements of the inter prediction operation, or the like. The syntax elements of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer (DPB) in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include syntax elements of the loop filter (e.g., a loop filter strength). In some embodiments, prediction data includes syntax elements of the loop filter when the prediction mode indicator of prediction data 206 indicates that inter prediction was used to encode the curr0ent BPU.

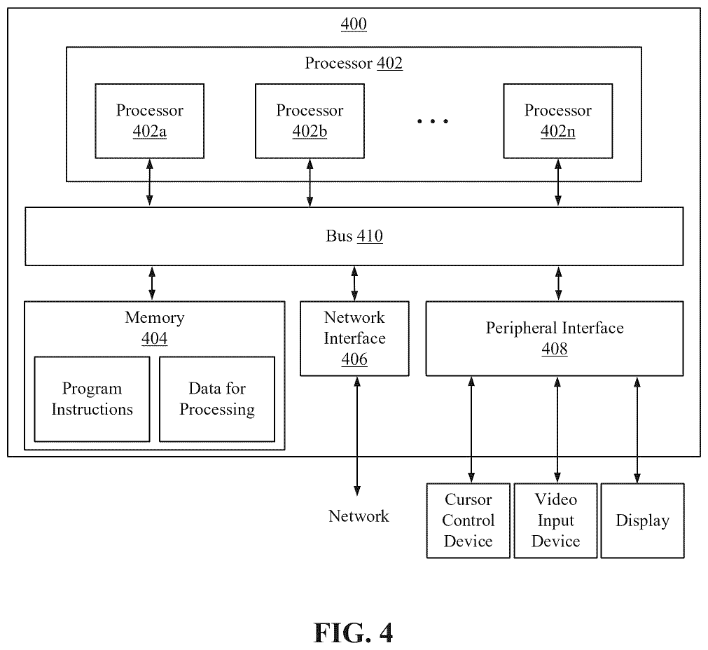

FIG. 4 is a block diagram of an exemplary apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

An Enhanced Compression Model (ECM) has been proposed and been used as a new software base for developing tools beyond the VVC standard.

Intra prediction used in the present disclosure is described.

According to the VVC standard, the luma component can be predicted by multiple intra prediction modes. These include planar mode, DC mode, angular mode, Multiple Reference Line (MRL) prediction mode, Intra Sub-partition (ISP) mode, Matrix-based Intra Prediction (MIP) mode and Intra Block Copy (IBC) mode.

In ECM, several video compression technologies beyond VVC are being explored. Some intra prediction modes are extended, and some new intra prediction modes are added, such as decoder-side intra mode derivation (DIMD) mode, template-based intra mode derivation (TIMD) mode, template-based multiple reference line intra prediction (TMRL), occurrence-based intra coding (OBIC) mode, spatial geometric partition mode (SGPM) and neural network-based intra prediction (NNIP) mode.

Consistent with the present disclosure, a planar mode can be used in the intra prediction. In the planar mode, the predicted value of the current sample is obtained from the reconstructed values of 4 reference samples: the left reference sample in the same row as the current sample, the above reference sample in the same column as the current sample, the reference sample on the bottom-left position adjacent to the current block and the reference sample on the top-right position adjacent to the current block. FIG. 5 illustrates exemplary reference samples used in planar mode, according to some embodiments of the present disclosure. Referring to FIG. 5, for example, using pred(x,y) to represent the predicted value of the current sample, using H to represent the height of the current block, and using W to represent the width of the current block, then the reconstructed values of the four reference samples used in planar mode can be respectively represented as rec(−1, y), rec(x,−1), rec(−1, H), and rec(W, −1), where (x, y) represents the coordinate positions of the current sample relative to the top-left position within the current block.

The planar mode generates the predicted value of the current sample based on the equation (1) to (3). In equation (1), an intermediate value predV(x, y) is obtained from rec(x,−1) and rec(−1, H); in equation (2), another intermediate value predH(x, y) is obtained from rec(−1, y) and rec(W,−1); finally, the two intermediate values are used to generate the predicted value of the current sample based on equation (3).

$$pred ( x , y ) = ( ( H - 1 - y ) * r e c ( x , - 1 ) + ( y + 1 ) * r e c ( - 1 , H ) ) << {log}_{2} W \qquad ( 1 )$$

$$pred ( x , y ) = ( ( W - 1 - x ) * r e c ( - 1 , y ) + ( x + 1 ) * r e c ( W , - 1 ) ) << {log}_{2} H \qquad ( 2 )$$

$$pred ( x , y ) = ( p r e d V ( x , y ) + p r e d H ( x , y ) + W * H ) >> ( {log}_{2} W + {log}_{2} H + 1 ) \qquad ( 3 )$$

The planar mode can be represented as index 0. PGP

In ECM, two additional planar modes where only the horizontal interpolation or only the vertical interpolation are used to obtain the predicted samples for luma.

For planar horizontal mode, only the horizontal linear interpolation is performed based on the left reference sample and the top-right reference sample to predict the current sample as:

$$pred ( x , y ) = ( ( W - 1 - x ) * r e c ( - 1 , y ) + ( x + 1 ) * r e c ( W , - 1 ) + ( W >> 1 ) ) >> {log}_{2} ( W ) \qquad ( 4 )$$

For planar vertical mode, only the vertical linear interpolation is performed based on the above reference sample and the bottom-left reference sample to predict the current sample as:

$$pred ( x , y ) = ( ( H - 1 - y ) * r e c ( x , - 1 ) + ( y + 1 ) * r e c ( - 1 , H ) + ( H >> 1 ) ) >> {log}_{2} ( H ) \qquad ( 5 )$$

Consistent with the disclosed embodiments, a DC mode can be used in the intra prediction.

In the DC mode, an average value of the left and above reference samples to the current block is used for prediction generation. In HEVC, every intra-coded block has a square shape and the length of each of its side (i.e., left and above) is a power of 2. Thus, no division operations are required to calculate the average value. In VVC, blocks can have a rectangular shape that necessitates the use of a division operation per block in the general case. To avoid division operations for DC prediction, only the longer side is used to compute the average value for non-square blocks. And for square blocks reference samples from both left and above sides are used to compute the average value. The DC mode can be represented as index 1.

Consistent with the disclosed embodiments, an angular mode can be used in the intra prediction.

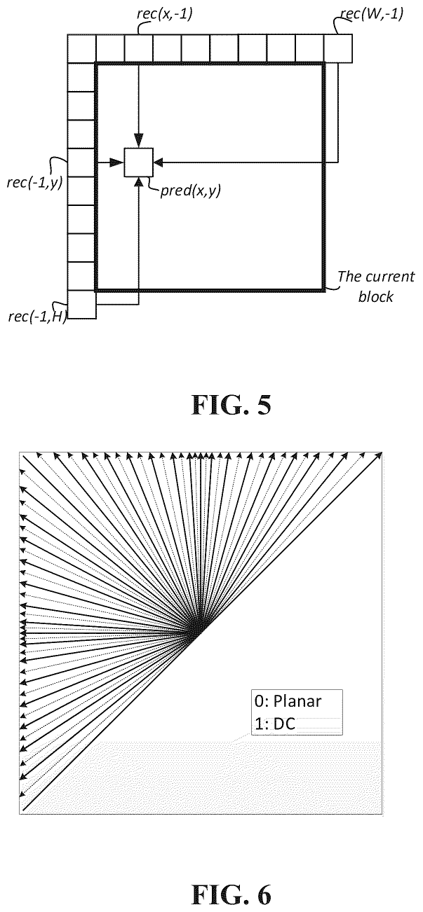

Angular intra prediction is a directional intra prediction method, which is extended from a prior implementation according to the HEVC standard. To capture the arbitrary edge directions presented in natural video, the VVC standard extends the number of angular intra prediction modes from 33 (as used in HEVC) to 65. FIG. 6 illustrates angular intra prediction modes in the VVC standard, according to some embodiments of the present disclosure. As shown in FIG. 6, the modes added in VVC are illustrated in broken lines. The 65 angle modes can be represented as index 2 to index 66 from bottom left to top right.

According to the VVC standard, to keep the complexity of the most probable mode (MPM) list generation low, an intra mode coding method with 6 MPMs is used by considering two available neighboring intra modes.

A unified 6-MPM list is used for intra blocks. The MPM list is constructed based on intra modes of the left and above adjacent block. Suppose the mode of the left is denoted as Left and the mode of the above block is denoted as Above, the unified MPM list is constructed as follows:
When an adjacent block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max−Min is equal to 1:
      MPM list→{Planar, Left, Above, Min−1, Max+1, Min−2}
   Otherwise, if Max−Min is greater than or equal to 62:
      MPM list→{Planar, Left, Above, Min+1, Max−1, Min+2}
   Otherwise, if Max−Min is equal to 2:
      MPM list→{Planar, Left, Above, Min+1, Min−1, Max+1}
   Otherwise:
      MPM list→{Planar, Left, Above, Min−1, −Min+1, Max−1}
If Left and Above are both angular and they are the same:
   MPM list→{Planar, Left, Left−1, Left+1, Left−2, Left+2}

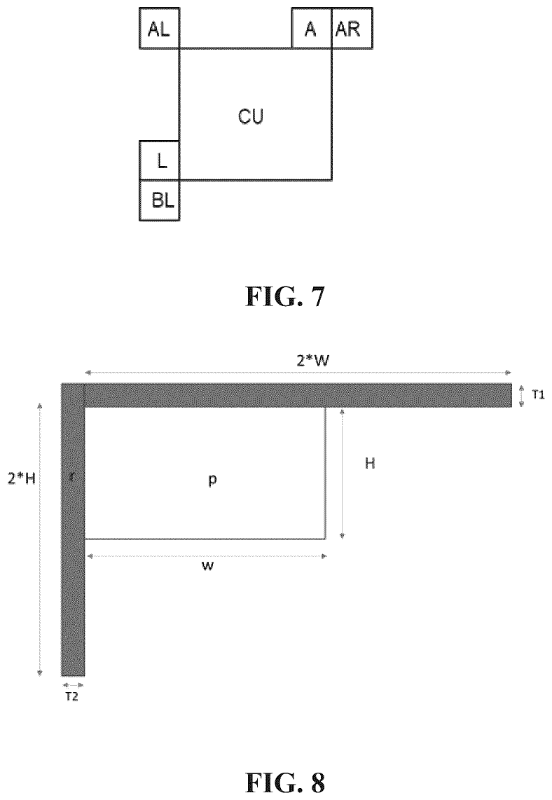

According to the ECM proposal, a secondary MPM list is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. FIG. 7 illustrates Adjacent blocks (L, A, BL, AR, AL) used in the derivation of a general MPM list, according to some embodiments of the present disclosure. The remaining entries are composed of the intra modes of the left (L), above (A), below-left (BL), above-right (AR), and above-left (AL) adjacent blocks as shown in FIG. 7, and decoder side intra mode derivation (DIMD) modes which are sorted in ascending order of SAD cost. Up to 5 modes with the smallest SAD cost are added. The SAD cost is computed between the prediction and the reconstruction samples of the template. The sorted directional modes with added offset are added into the general MPM list, and then the default modes, until the general MPM list with 22 entries is constructed.

If a block is vertically oriented, the order of neighboring blocks is A, L, BL, AR, AL; otherwise, it is L, A, BL, AR, AL.

According to the ECM proposal, the intra modes of the non-adjacent blocks can also be added to the MPM list. And the first MPM list except the planar mode is sorted by applying the intra prediction mode of each entry to a template of the current block and calculating the sum of absolute difference (SAD) values between predicted samples and reconstructed samples of the template.

According to the ECM proposal, some of the conventional intra prediction modes (planar, DC and the 65 angular modes) may be replaced by matrix-based position dependent intra prediction (PDP) mode. In the matrix based intra prediction mode, a matrix of weights, which are defined for a block shape and intra mode index, is introduced. Those weights are multiplied by the neighbor reference template to derive the predicted values of the current block. FIG. 8 illustrates exemplary L shaped neighborhood for a given predicted block, according to some embodiments of the present disclosure. The weights are applied to the reference samples of the L shaped causal neighborhood template as shown in the FIG. 8.

The reference samples in the causal neighborhood are denoted as r, and F(x, y) is the matrix of weights. Then the predicted value pred(x, y) can be derived as:

$$pred ( x , y ) = {\sum }_{k} F ( x , y , k ) * r ( k ) \qquad ( 6 )$$

where k denotes the index of the reference sample in the template.

The prediction is used for block size with both width and height up to 32 (except for 4×32, 32×4, 8×32, and 32×8). The template size is 2 for blocks with both width and height up to 16 and the modes with index 0, 1, and (2+2×k) are replaced. For other blocks, template size is set to 1 and the modes with index 0, 1, and (2+4×k) are replaced. The prediction is only performed for 16×16 positions, and the rest of the samples are generated by bilinear interpolation. For all block sizes, block shape and mode-based symmetry is used. Reference length is set to W and H for modes with index greater than 18 and less than 50 and set to 2×W and 2×H for other modes.

Consistent with the disclosed embodiments, a decoder side intra mode derivation (DIMD) mode can be used in the intra prediction.

When DIMD is applied, a number of intra modes are derived from the reconstructed neighbor samples by computing a histogram of gradients (HoG), which is built by applying edge operators to a reference area. The edge operators are used to derive the direction and magnitude (amplitude) of gradients within the area covered by an edge operator. The selection of an edge operator that should be applied to the reference area, is based on the size of a current (predicted) block.

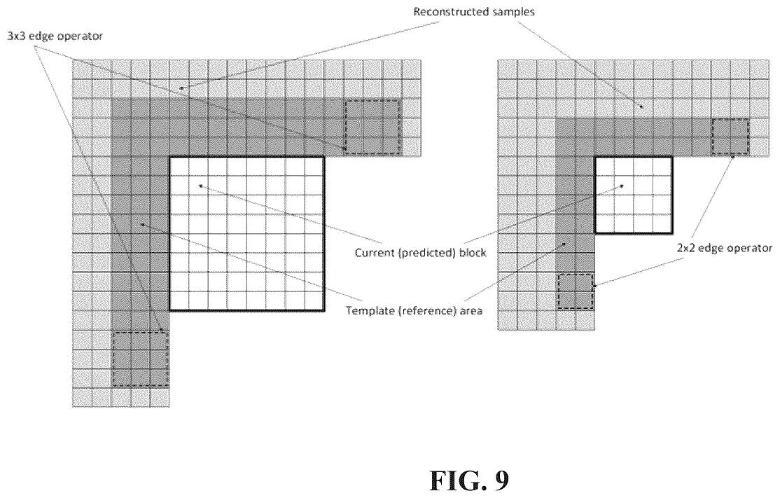

FIG. 9 illustrates exemplary edge operator options, according to some embodiments of the present disclosure. As shown in FIG. 9, the horizontal Fₓ and vertical F_{y} filters of the 2×2 operator are defined as follows:

$${F}_{x} = [ \begin{matrix}- 1 & - 1 \\ 1 & 1\end{matrix} ] \qquad ( 7 )$$

$${F}_{y} = [ \begin{matrix}1 & - 1 \\ 1 & - 1\end{matrix} ] \qquad ( 8 )$$

The horizontal Fₓ and vertical F_{y} filters of the 3×3 operator are defined as follows:

$${F}_{x} = [ \begin{matrix}- 1 & - 2 & - 1 \\ 0 & 0 & 0 \\ 1 & 2 & 1\end{matrix} ] \qquad ( 9 )$$

$${F}_{y} = [ \begin{matrix}1 & 0 & - 1 \\ 2 & 0 & - 2 \\ 1 & 0 & - 1\end{matrix} ] \qquad ( 10 )$$

In particular, up to seven up to five intra modes are derived if the block size area is larger than or equal to 128 samples, and up to five intra modes are derived otherwise. Each derived intra mode is used to form an intra predictor. These predictors are combined with the non-directional predictor (planar or block vector based predictor) with the weights derived from the histogram of gradients. The decision between the non-directional modes is taken according to the template cost. Specifically, the block vectors of all adjacent and non-adjacent merge candidates (coded in IntraTMP or IBC) are compared to planar prediction on the reconstructed template. The template cost (for example, SATD) is used to select the best predictor among them.

The histogram of gradients for the templates above, left, and left-above is computed separately. The computation of the histogram of gradients for the template above-left can be used. For intra slices, in case the block size area is smaller than 128 samples, then the histogram of gradients for the templates above and left is also computed. Otherwise, the computation of the histogram of gradients for the templates above and left is modified, so that an adaptive number of template samples is considered. For each sample in the template above or left, a direction, and an amplitude are computed and the histogram is updated accordingly. The amplitude is scaled with a weight extracted using the distance from the current block from the following look-up table (LUT):

$$WeightTable [ 12 ] = \{ 4 , 4 , 2 , 2 , 1 , 1 , 1 , 1 , 1 , 1 , 1 , 1 \} \qquad ( 11 )$$

In addition, a support direction is computed on the sample immediately above the current sample (for the template above) or on the sample immediately on the left of the current sample (for the template left). If the absolute difference between the support direction and the computed direction for the current sample is smaller than or equal to one, then the amplitude is scaled as follows:

$$Amp = Amp + ( Amp >> 3 ) \qquad ( 12 )$$

The total sum of all amplitudes in the histogram is then calculated. The computation of the histogram of gradients is terminated in case this total sum exceeds a pre-determined threshold. Otherwise, another template sample is considered, where samples are extracted from an extended template comprising more lines above and more lines of the left of the current block, up to a maximum 12 lines. The threshold is computed as follows: first, the DIMD template size S is computed; then it is scaled by a pre-determined factor F. For the template above, if the block above the current block has a height greater than 8 samples, and it has a width greater or equal than the width of the current block, then F=2200, otherwise, F=1700. Similarly for the template left, if the block on the left of the current block has a width greater than 8 samples, and it has a height greater or equal than the height of the current block, then F=2200, otherwise, F=1700. The threshold is then computed as the product of S and F.

The division operations in weight derivation are performed utilizing the same lookup table (LUT) based integerization scheme used by the Cross-Component Linear Model (CCLM). For example, the division operation in the orientation calculation Orient=G_y/G_x is computed by the following LUT-based scheme:

$$x = Floor ( Log 2 ( G x ) ) \qquad ( 13 )$$

$$normDiff = ( ( Gx << 4 ) >> x ) \& 15$$

$$x + - ( 3 + ( normDiff ! - 0 ) ? 1 : 0 )$$

$$Orient = ( Gy * ( DivSigTable [ normDiff ] \vert 8 ) + ( 1 << ( x - 1 ) ) ) >> x ,$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \}$$

For a block of size W×H, the weight for each of the five derived modes is modified if the one the above or left histogram magnitudes is twice larger than the other one. In this case, the weights are location dependent and computed as follows:

If the above histogram is twice the left, then:

$${w}_{i} ( x , y ) = {wDimd}_{i} + {Δ}_{i} - 2 {Δ}_{i} \frac{y}{( H - 1 )} . \qquad ( 14 )$$

If the left histogram is twice the above, then:

$${w}_{i} ( x , y ) = {wDimd}_{i} + {Δ}_{i} - 2 {Δ}_{i} \frac{x}{( W - 1 )} . \qquad ( 15 )$$

where wDimdᵢ is the unmodified uniform weight of the DIMD, Δᵢ is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

Finally, note the region of neighboring reconstructed samples used for computing the histogram of gradients is modified, depending on reconstructed samples availability. The region of decoded reference samples of current W×H luma coding block (CB) is extended towards the above-right side if available, up to W additional columns. It is extended towards the bottom-left side if available, up to H additional rows.

Consistent with the present disclosure, occurrence-based intra coding (OBIC) can be used in the intra prediction.

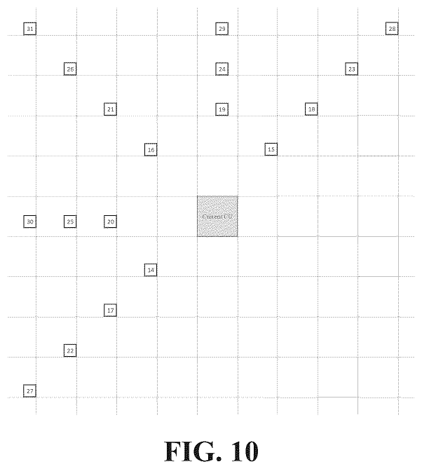

The occurrence-based intra coding (OBIC) derives the intra prediction modes of the current block based on the sample-wise occurrence of the intra modes in the spatial neighborhood of the block. For this, adjacent and non-adjacent spatial neighboring blocks are checked and the intra prediction modes of the blocks are collected into an occurrence histogram. Instead of Histogram of Gradients (HoGs) as in DIMD, the OBIC method uses the Histogram of Occurrences, which consists of the intra modes and their sample-wise occurrences. The occurrence values are calculated based on the number of samples that are coded in a certain intra prediction mode in that neighborhood. For example, if a uiWidth×uiHeight block is coded with an intra prediction mode (IPM), the occurrence of the mode in that block is calculated as:

$$Histogram [ IPM ] += uiWidth \times uiHeight ;$$

where uiWidth and uiHeight are the width and height of a spatial neighboring block. The occurrences of the existing modes from the spatial neighborhood blocks are accumulated into the histogram. FIG. 10 illustrates exemplary non-adjacent spatial neighboring blocks that are used in OBIC mode's histogram generation, according to some embodiments of the present disclosure.

Up to five angular modes with the highest occurrence along with the planar mode or block vector-based prediction (same as in DIMD) are selected from the histogram and used for final prediction by blending the prediction of the selected modes.

Some blocks, as mentioned below, use more than one intra mode for prediction. In such cases, all the intra modes of such blocks are selected and used when creating the OBIC histogram:
DIMD: up to 5 angular modes
TIMD: up to 2 modes
SGPM: 2 modes
OBIC: up to 5 angular modes

Moreover, the virtual intra prediction modes (VIPMs) of following blocks are considered only in inter slices when creating the histogram of OBIC mode:
MIP block
IntraTMP block
EIP block

The blending weights are calculated similar to the DIMD mode, but instead of using gradient values from the template, the occurrence values are used for OBIC. Moreover, the planar mode's weight is also decided similar to DIMD mode.

The OBIC mode is used as a sub-mode of DIMD tool and is applied to only luma blocks. Moreover, the mode is disabled for blocks that have less than 64 samples.

Consistent with the disclosed embodiments, template-based intra mode derivation (TIMD) can be used in the intra prediction.

For each intra prediction mode in MPMs, as well as the wide-angle modes if the above-right and/or bottom-left reference samples are available, SATD between the prediction and reconstruction samples of the template is calculated. First two intra prediction modes with the minimum SATD and one non-angular intra prediction mode (i.e., DC or Planar) with the lowest SATD cost are selected as the TIMD modes. These three TIMD modes are fused with the weights after applying position dependent intra prediction combination (PDPC) process, and such weighted intra prediction is used to code the current CU. PDPC is included in the derivation of the TIMD modes.

The conditions below are checked to determine whether the non-angular intra prediction mode is used in fusion:
the non-angular intra prediction mode is different from the two selected intra prediction modes.
costMode3<1.5×costMode1, where the costMode3 is the SATD cost of the non-angular intra prediction mode and costMode1 is the SATD cost of the first intra prediction mode.

If both of the conditions are true, three intra prediction modes are used to generate the prediction. And the weights of each intra prediction mode are computed from SATD cost based on the following equation:

$${weight}_{i} = \frac{sumSATD - {costMode}_{i}}{2 \times sumSATD} , \qquad ( 16 )$$

$$sumSATD = {\sum }_{j = 1}^{3} {costMode}_{i}$$

Otherwise, the non-angular intra prediction mode is not used in prediction. And the costs of the two selected modes are compared with a threshold, in the test the cost factor of 2 is applied based on the following:

$$costMode 2 < 2 \times costMode 1.$$

If this condition is true, the fusion is applied, otherwise the only model is used.

Weights of the modes are computed from their SATD costs as follows:

$$weight 1 = costMode 2 / ( costMode 1 + costMode 2 )$$

$$weight 2 = 1 - weight 1$$

The division operations are conducted using the same lookup table (LUT) based integerization scheme used by the CCLM.

Besides, location-dependent sample-based fusion used in DIMD fusion process is used for the TIMD fusion but the location-dependent criterion applying to amplitudes of the selected predictors is replaced by a SATD cost-based criteria. The location-dependent criterion is determined from a ratio of the normalized SATD of the selected TIMD predictors computed in above and left template area.

In ECM encoder combination of TIMD and ISP (TIMD-ISP), and the combination of TIMD and MRL (TIMD-MRL) are disabled.

Consistent with the present disclosure, spatial Geometric partitioning mode (SGPM) can be used in the intra prediction.

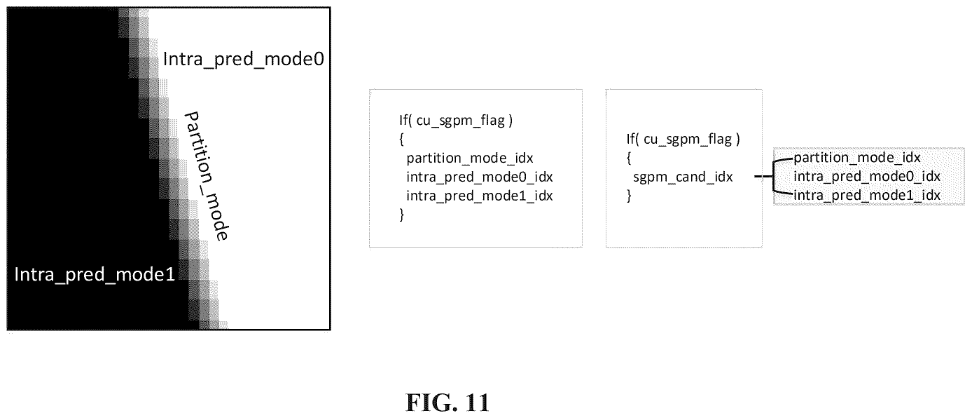

SGPM is an intra mode that resembles the inter coding tool of geometric partition mode (GPM), where the two prediction parts are generated from intra predicted process. FIG. 11 illustrates exemplary spatial GPM candidates, according to some embodiments of the present disclosure. In this mode, referring to FIG. 11, a candidate list is built with each entry containing one partition split and two intra prediction modes. 26 partition modes and 9 intra prediction modes are used to form the combinations. The length of the candidate list is set equal to 16. The selected candidate index is signaled.

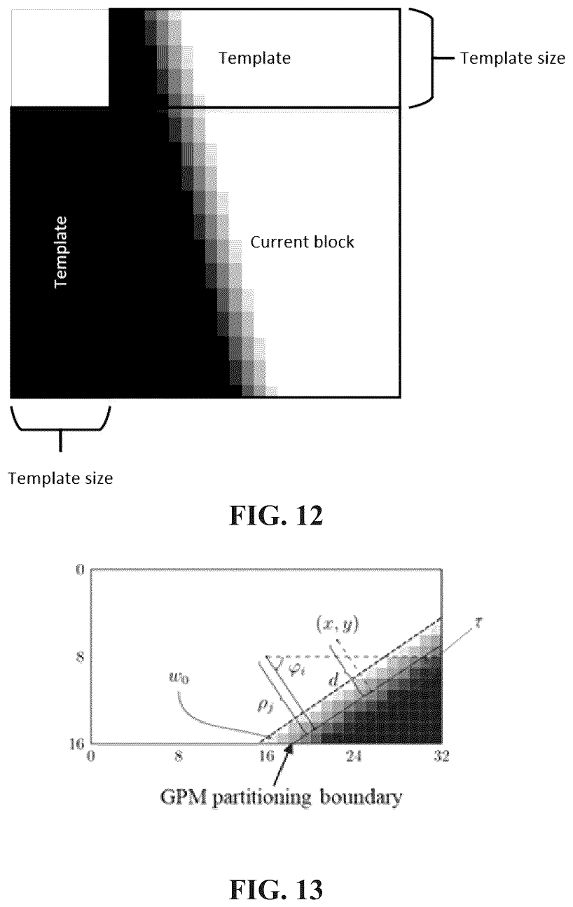

FIG. 12 illustrates exemplary GPM template, according to some embodiments of the present disclosure. As shown in FIG. 12, the list is reordered using template where SAD between the prediction and reconstruction of the template is used for ordering. The template size is fixed to 1.

For each partition mode, an IPM list is derived for each part using the same intra-inter GPM list derivation as described above. The IPM list size is set to 3. In the list, TIMD derived mode is replaced by 2 derived modes with horizontal and vertical orientations. The list is further augmented with block-vector based prediction candidates obtained from the adjacent and non-adjacent merge candidates coded in IntraTMP or IBC mode. The template cost is employed to select the up to 6 block vectors. The final list contains up to 9 predictors: 3 regular intra modes and up to 6 block vectors-based predictors.

The SGPM mode is applied with a restricted blocks size: 4<=width<=64, 4<=height<=64, width<height×8, height<width×8, width×height>=32.

A PPS flag is coded to indicate whether no blending of two intra predictions is allowed. FIG. 13 illustrates an exemplary GPM blending, according to some embodiments of the present disclosure. When this PPS flag is set to false, the following adaptive blending is also used for spatial GPM, where blending depth T is derived as follows:
If min(width, height)==4, ½ τ is selected
else if min(width, height)==8, τ is selected
else if min(width, height)==16, 2 τ is selected
else if min(width, height)==32, 4 τ is selected
else, 8 τ is selected.

Otherwise (the PPS flag is set to true), ¼ τ is always used for spatial GPM coded blocks to make sure no blending is used when SGPM block has partition angles completely horizontal or vertical, and much narrower blending width is used when SGPM block has other partition angles. It is noted that the flag is set to true in current Common Test Conditions (CTC) for the screen content videos.

Consistent with the present disclosure, neural network-based intra prediction can be used in the intra prediction.

The neural network-based intra prediction mode contains 6 neural networks (also refers to 6 neural network models), each predicting luma CBs of a different size in {4×4,8×4,16×4,8×8,16×8,16×16}. For a given W×H luma CB, the used neural network takes the context made of N reference samples around this luma CB, as shown in FIG. 9, to return the W×H predicted block. For block sizes non natively supported by a model, similarly to MIP in VVC, the reference samples are transposed and/or downsampled.

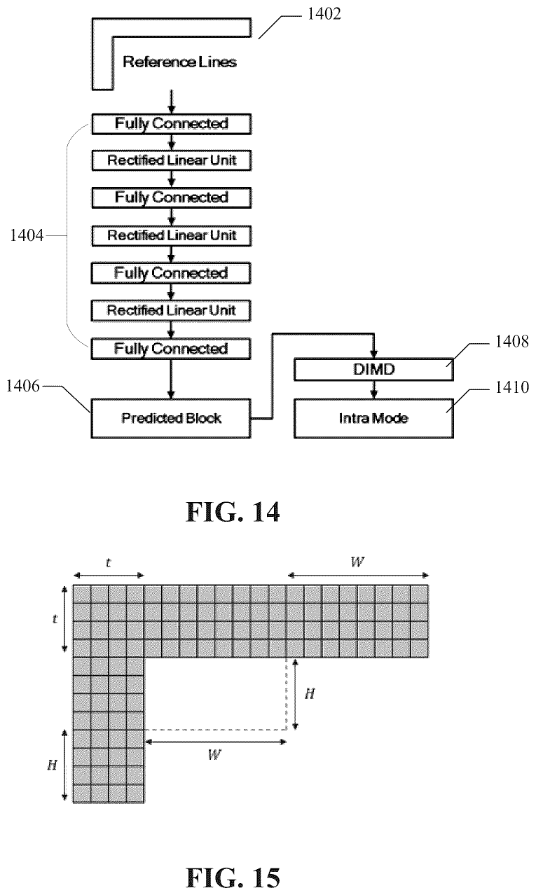

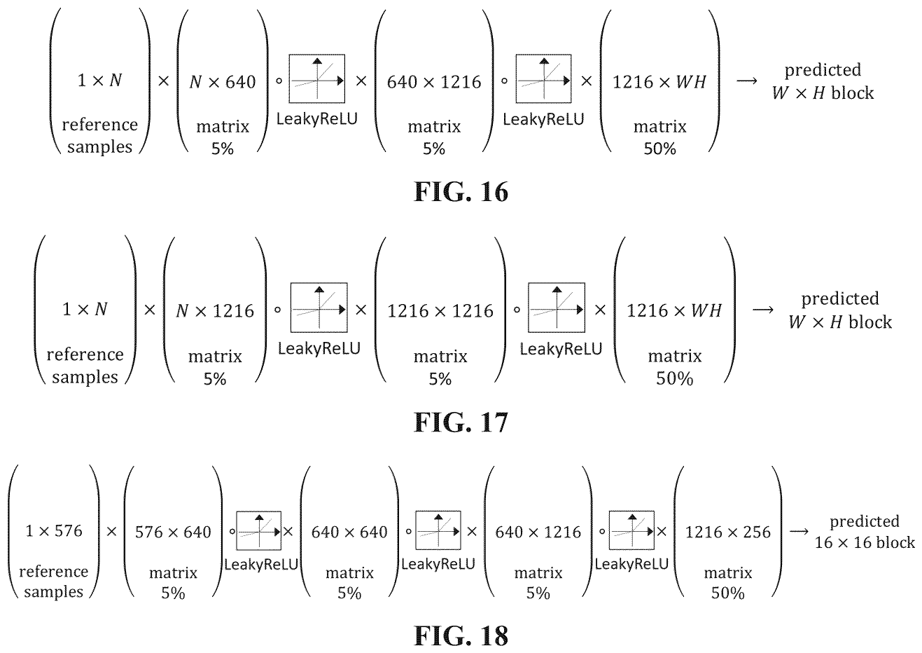

The architectures of the models are described in detail in FIG. 14 to FIG. 18. FIG. 14 illustrates an exemplary network architecture, according to some embodiments of the present disclosure. FIG. 15 illustrates an exemplary N reference samples to predict a given W×H luma CB, according to some embodiments of the present disclosure. FIG. 16 shows an exemplary framework illustrating sequential matrix multiplications and LeakyReLUs (piecewise-linear functions), according to some embodiments of the present disclosure. FIG. 17 shows another exemplary framework illustrating sequential matrix multiplications and LeakyReLUs (piecewise-linear functions), according to some embodiments of the present disclosure. FIG. 18 shows another exemplary framework illustrating sequential matrix multiplications and LeakyReLUs (piecewise-linear functions), according to some embodiments of the present disclosure. The number of non-zero weights for each weight matrix is displayed. A sparse vector-matrix multiplication processes chunks of 8 non-zero coefficients. The LeakyReLU used can be defined based on the following piecewise-linear function:

$$LeakyReLU ( x ) = \{ \begin{matrix}x , & x \geq 0 \\ x >> 4 , & x < 0\end{matrix} \qquad ( 17 )$$

Consistent with FIGS. 14 to 18, for a current W×H luma CB selecting the NNIP mode, at stage 1402, N reference samples for the prediction are determined as show in FIG. 15 as an example. At stage 1404, multiple LeakyReLU are performed, and at step 1460, a predicted block is obtained. FIG. 16 to FIG. 18 illustrate some different examples of NN model for different block sizes. For example, the NN model shown in FIG. 16 can be utilized by CBs with a block size of 4×4/8×4 or those transformed to 4×4/8×4 (downsampled or transposed). The NN model shown in FIG. 17 can be utilized by CBs with a block size of 8×8/16×4/16×8 or those transformed to 8×8/16×4/16×8 (downsampled or transposed). The NN model shown in FIG. 18 can be utilized by CBs with a block size of 16×16 or those transformed to 16×16 (downsampled and/or transposed). Then, at stage 1408, a DIMD is applied to the predicted block that is obtained by the NN model. Finally, at stage 1410, regarding the implicit transform mapping in Multiple Transform Selection (MTS) and Low-Frequency Non-Separable Transform (LFNST)/Non-Separable Primary Transform (NSPT), an equivalent intra prediction mode is derived. In some cases, for a given luma CB of size larger than 64 luma samples and selecting the NNIP mode, an alternative equivalent intra prediction mode is used for LFNST/NSPT. Specifically, in addition to the first equivalent intra prediction mode obtained by applying DIMD to the predicted block, Planar is used as additional equivalent intra mode candidate. In this case, a CU-level flag indicating the equivalent intra mode index is signaled.

For the current W×H luma CB whose top-left pixel is located at (x, y) in the current luma channel, if a neural network can predict luma CB of this size and the context of this luma CB does not go out of the bounds of the current luma channel, i.e., x>t && y>t, the NNIP mode is signaled via a NN flag placed after a Block-based Differential Pulse-Code Modulation (BDPCM) flag and before the DIMD flag.

In the present disclosure, inter prediction can be used. Consistent with the present disclosure, geometric partitioning mode (GPM) can be used in the inter prediction.

In VVC, a mode called Geometric partitioning mode (GPM) is supported. In the GPM mode, a geometric partitioning mode is supported for inter prediction. The geometric partitioning mode is signaled using a CU-level flag as one kind of merge mode, with other merge modes including a regular merge mode, a merge with motion vector difference (MMVD) mode, a combined inter and intra prediction (CIIP) mode, and a subblock merge mode. In total 64 partitions are supported by geometric partitioning mode for each possible CU size with excluding 8×64 and 64×8.

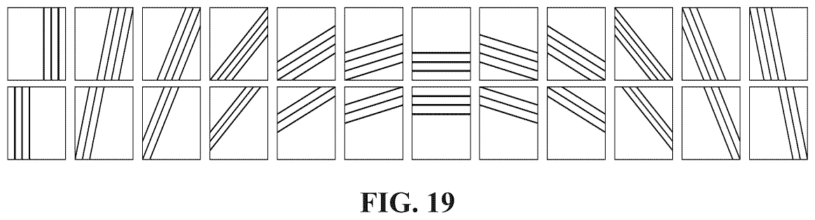

FIG. 19 illustrates examples of the GPM splits grouped by identical angles, according to some embodiments. As shown in FIG. 19, when this mode is used, a CU is split into two parts by a geometrically located straight line. The location of the splitting line is mathematically derived from the angle and offset parameters of a specific partition. Each part of a geometric partition in the CU is predicted using its own motion.

If GPM is used for the current CU, a geometric partition index indicating the partition mode of the geometric partition (angle and offset), and two merge indices (one for each partition) are further signaled. The number of maximum GPM candidate size is signaled explicitly in SPS and specifies syntax binarization for GPM merge indices. After predicting each part of the geometric partition, the sample values along the geometric partition edge are adjusted using a blending processing with adaptive weights. This is the prediction signal for the whole CU, and transform and quantization process will be applied to the whole CU as in other prediction modes.

Consistent with the present disclosure, GPM with inter and intra prediction can be used in the inter prediction.

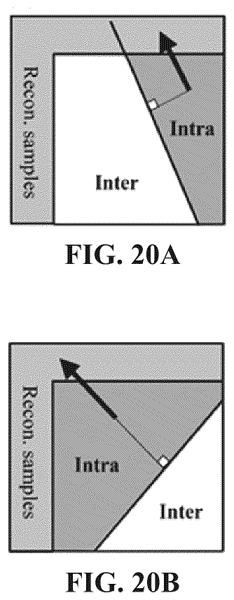

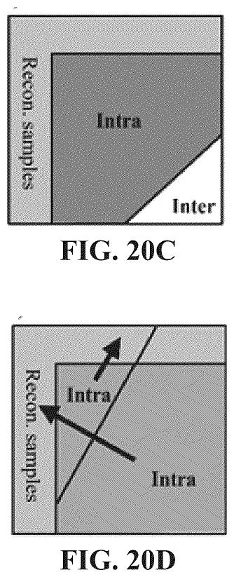

In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. The IPM candidate list size is pre-defined as 3. FIG. 20A illustrates a parallel mode for GPM with inter and intra prediction, according to some embodiments of the present disclosure. FIG. 20B illustrates a perpendicular mode for GPM with inter and intra prediction, according to some embodiments of the present disclosure. FIG. 20C illustrates a planar mode for GPM with inter and intra prediction, according to some embodiments of the present disclosure. As shown in FIG. 20A, the available IPM candidates are the parallel angular mode against the GPM block boundary (Parallel mode). As shown in FIG. 20B, the available IPM candidates are the perpendicular angular mode against the GPM block boundary (Perpendicular mode). As shown in FIG. 20C, the available IPM candidates are the Planar mode. FIG. 20D illustrates another example of GPM with intra and intra prediction, according to some embodiments of the present disclosure. As shown in FIG. 20D, GPM with intra and intra prediction is restricted to reduce the signaling overhead for IPMs and avoid an increase in the size of the intra prediction circuit on the hardware decoder. In addition, a direct motion vector and IPM storage on the GPM-blending area is introduced to further improve the coding performance.

For IPM derivation, Parallel mode is registered first. Therefore, max two IPM candidates derived from the decoder-side intra mode derivation (DIMD) method and/or the neighboring blocks can be registered if there is not the same IPM candidate in the list. As for the neighboring mode derivation, there are five positions for available neighboring blocks at most, but they are restricted by the angle of GPM block boundary as shown in Table 1, which are already used for GPM with template matching (GPM-TM).

TABLE 1
The position of available neighboring blocks for IPM candidate derivation based on the angle
of GPM block boundary. A and L denote the above and left side of the prediction block.

| Angle of GPM | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

GPM-intra can be combined with GPM by merging with motion vector difference (GPM-MMVD). TIMD is used for on IPM candidates of GPM-intra to further improve the coding performance. The Parallel mode can be registered first, then IPM candidates of TIMD, DIMD, and neighboring blocks.

Consistent with the present disclosure, combined inter and intra prediction (CIIP) can be used in the inter prediction.

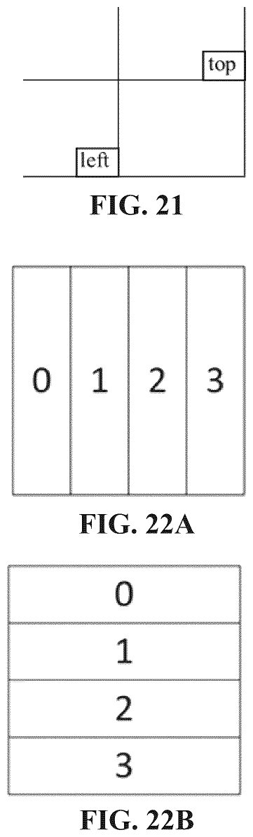

In VVC, when a CU is coded in merge mode, if the CU contains at least 64 luma samples (that is, CU width times CU height is equal to or larger than 64), and if both CU width and CU height are less than 128 luma samples, an additional flag is signaled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. FIG. 21 illustrates top and left neighboring blocks used in CIIP weight derivation, according to some embodiments of the present disclosure. The intra and inter prediction signals are combined using weighted averaging, where the weight value is calculated depending on the coding modes of the top and left neighboring blocks (as shown in FIG. 21) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) >> 2 \qquad ( 18 )$$

The first aspect of CIP improvement in ECM is the subblock CIP. A subblock-based merge candidate may be used to generate the inter signal of CIIP, where the same subblock-based merge candidate list used by affine and sbTMVP is utilized.

When CIP flag is true and CIIP-TM flag is false, a subblock-based CIIP flag is signaled. If subblock-based CIIP flag is true, an index indicating specific candidate in the subblock-based merge list is signaled, and TIMD is used to generate intra signal by default thus no CIIP-PDPC flag signaled any more.

The second aspect of CIP improvement in ECM is the combination of CIIP with TIMD and TM Merge.

In CIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIP. Specifically, the intra prediction mode with the smallest SATD values in the TIMD mode list is selected and mapped to one of the 67 regular intra prediction modes.

In addition, it is also proposed to modify the weights (wIntra, wInter) if the derived intra prediction mode is an angular mode. FIG. 22A and FIG. 22B illustrate exemplary division method for angular modes, according to some embodiments of the present disclosure. For near-horizontal modes (2<=angular mode index<34), the current block is vertically divided as shown in FIG. 22A; for near-vertical modes (34<=angular mode index<=66), the current block is horizontally divided as shown in FIG. 22B.

The (wIntra, wInter) for different sub-blocks are shown in Table 2.

TABLE 2
The modified weights
used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

The present disclosure provides methods to solve problems existing in the above-described prediction techniques.

In the current ECM, the neural network-based intra prediction (NNIP) mode is implemented as an independent prediction mode, wherein the predicted samples are solely derived from the output of the neural network model.

In the first aspect, enabling NNIP mode for more block sizes may improve coding efficiency.

In the second aspect, multiple predictor fusion techniques have been widely used in the current ECM, such as TIMD mode and DIMD mode. By fusing the NNIP predictor with other prediction modes, the coding performance can be improved in specific scenarios.

In the third aspect, NNIP mode is taken as planar mode or equivalent intra mode derived by DIMD process on its prediction values for exist coding tools which need intra candidate derivation. Using the original NNIP mode instead of the representation traditional intra mode can provide more accurate prediction samples.

Besides, for the CIP mode, the intra-inter weights are determined by the intra angular mode and the weights are assigned at the sub-block level in the current ECM. However, the weights are not gradual at the boundary of sub-blocks which may cause artefacts and harm coding efficiency. Therefore, it is proposed to modify the intra-inter weights for higher coding efficiency.

In the present disclosure, the following methods described can be used to solve one or more of the above-described problems.

In the current NNIP design, 6 NN models are used for prediction and used to predict a block size in {4×4, 8×4, 16×4, 8×8, 16×8, 16×16}, respectively. For block sizes non directly supported by a model, similarly to MIP in VVC, the reference samples are transposed and/or down sampled. Therefore, the 6 neural network-based (NN) models can support more block sizes. In the current NNIP design, all block sizes supported by each NN model are shown in Table 3.

TABLE 3
Block sizes supported by each NN model

| | NN model predicting block size W × H | | | | | |
|---|---|---|---|---|---|---|
| | 4 × 4 | 8 × 4 | 16 × 4 | 8 × 8 | 16 × 8 | 16 × 16 |
| block sizes supported | 4 × 4 | 8 × 4, 4 × 8 | 16 × 4, 4 × 16, | 8 × 8 | 16 × 8, 8 × 16, | 16 × 16, 32 × 16, |
| | | | 32 × 4, 4 × 32 | | 32 × 8, 8 × 32 | 16 × 32, 32 × 32, |
| | | | | | | 64 × 64 |

Referring to Table 3, the block sizes listed in the second row (“block size supported”) can be predicted using the 6 NN models, while for other block sizes that are not included in Table 3, the NNIP mode cannot be used.

Embodiments of the present disclosure provide methods for extending the NNIP mode to more block sizes to improve coding efficiency.

In some embodiments, NNIP mode is enabled for more block sizes.

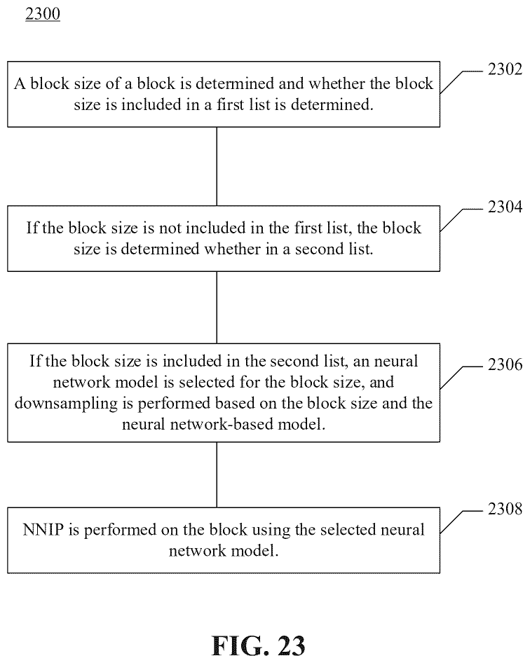

FIG. 23 is a flowchart of an exemplary method for extending the NNIP mode, according to some embodiments of the present disclosure. Method 2300 can be performed by an encoder (e.g., by process 200A of FIG. 2A or 200B of FIG. 2B), performed by a decoder (e.g., by process 300A of FIG. 3A or 300B of FIG. 3B), or performed by one or more software or hardware components of an apparatus (e.g., apparatus 400 of FIG. 4). For example, a processor (e.g., processor 402 of FIG. 4) can perform method 2300. In some embodiments, method 2300 can be implemented by a computer program product, embodied in a computer-readable medium, including computer-executable instructions, such as program code, executed by computers (e.g., apparatus 400 of FIG. 4). Referring to FIG. 23, method 2300 may include the following steps 2302 to 2308.

At step 2302, a block size of a block is determined and whether the block size is included in a first list is determined. For example, whether the block size is included in the list of {4×4, 8×4, 4×8, 16×4, 4×16, 32×4, 4×32, 8×8, 16×8, 8×16, 32×8, 8×32, 16×16, 32×16, 16×32, 32×32, 64×64} is determined. If the block size is included in the list, a corresponding NN model is used for prediction.

At step 2304, if the block size is not included in the first list, the block size is determined whether in a second list. In some embodiments, the 6 neural network (NN) models can be used for block sizes in a list of {64×8, 8×64, 64×16, 16×64, 64×32, 32×64}.

At step 2306, if the block size is included in the second list, a neural network model is selected for the block size, and downsampling is performed based on the block size and the NN model. In some embodiments, before performing the down sampling, transpose transformation is performed. For example, for a block size M×N, where M and N are integer and M is greater than or equal to N, the downsampling is performed; and for a block size M×N, where M and N are integer and M is less than N, the transpose transformation is performed to obtain a size of N×M, and then the downsampling is performed to adapt the selected NN model.

In some embodiments, for block sizes {64×8, 8×64}, a 16×4 NN model is selected. Specifically, for block with width equal to 64 and height equal to 8, i.e., 64×8, a 4×down-sampling along the width direction and 2×down-sampling along the height direction is performed to obtain input samples needed for 16×4 NN model. For block with width equal to 8 and height equal to 64, i.e., 8×64, a transpose transformation is performed first, and then a 4×down-sampling along the width direction and 2×down-sampling along the height direction is performed.

In some embodiments, for block sizes {64×8, 8×64}, the 16×8 NN model is selected. Specifically, for block with width equal to 64 and height equal to 8, i.e., 64×8, a 4× down-sampling along the width direction is performed to obtain input samples needed for 16×8 NN model. For block with width equal to 8 and height equal to 64, i.e., 8×64, transpose transformation is performed first, and then a 4×down-sampling along the width direction is performed.

In some embodiments, for block sizes {64×16, 16×64}, the 16×16 NN model is selected. Specifically, for block with width equal to 64 and height equal to 16, i.e., 64×16, a 4× down-sampling along the width direction is performed to obtain input samples needed for 16×16 NN model. For block with width equal to 16 and height equal to 64, i.e., 16×64, a 4×down-sampling along the height direction is performed to obtain input samples needed for 16×16 NN model.

In some embodiments, for block sizes {64×16, 16×64}, the 16×8 NN model is selected. Specifically, for block with width equal to 64 and height equal to 16, i.e., 64×16, a 4× down-sampling along the width direction and 2×down-sampling along the height direction is performed to obtain input samples needed for 16×8 NN model. For block with width equal to 16 and height equal to 64, i.e., 16×64, transpose transformation is performed first, and then a 4× down-sampling along the width direction and 2×down-sampling along the height direction is performed.

In some embodiments, for block sizes {64×32, 32×64}, the 16×16 NN model is selected. Specifically, for block with width equal to 64 and height equal to 32, i.e., 64×32, a 4× down-sampling along the width direction and 2×down-sampling along the height direction is performed to obtain input samples needed for 16×16 NN model. For block with width equal to 32 and height equal to 64, i.e., 32×64, transpose transformation is performed first, and then a 4× down-sampling along the width direction and 2×down-sampling along the height direction is performed.

In some embodiments, for block sizes {64×16, 16×64, 64×32, 32×64}, the 16×16 NN model is selected. Similar transpose and/or down sampling are performed.

In some embodiments, for block sizes {64×8, 8×64}, the 16×8 NN model is selected. At the same time, for block sizes {64×16, 16×64, 64×32, 32×64}, the 16×16 NN model is used. Similar transpose and/or down sampling are performed.

In some embodiments, for block sizes {64×8, 8×64}, the 16×8 NN model is selected. For block sizes {64×16, 16×64}, the 16×8 NN model is used. For block sizes {64×32, 32×64}, the 16×16 NN model is used. Similar transpose and/or down sampling are performed

In some embodiments, for block sizes {64×8, 8×64}, the 16×4 NN model is selected. For block sizes {64×16, 16×64, 64×32, 32×64}, the 16×16 NN model is used. Similar transpose and/or down sampling are performed.

In some embodiments, for block sizes {64×8, 8×64}, the 16×4 NN model is selected. For block sizes {64×16, 16×64}, the 16×8 NN model is used. For block sizes {64×32, 32×64}, the 16×16 NN model is used. Similar transpose and/or down sampling are performed.

At step 2308, NNIP is performed on the block using the selected neural network model.

Embodiments of the present disclosure further provide methods for fusing NNIP with other modes to improve coding performance.

In current ECM design, the NNIP predictor cannot be fused with other modes, which may limit the coding performance.

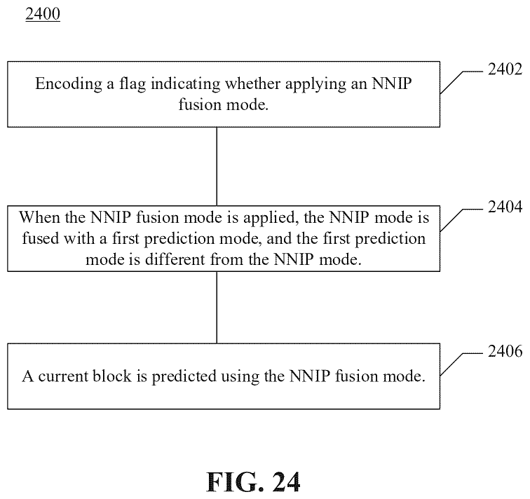

FIG. 24 is a flowchart of an exemplary method for fusing NNIP mode with other modes, according to some embodiments of the present disclosure. Method 2400 can be performed by an encoder (e.g., by process 200A of FIG. 2A or 200B of FIG. 2B), or performed by one or more software or hardware components of an apparatus (e.g., apparatus 400 of FIG. 4). For example, a processor (e.g., processor 402 of FIG. 4) can perform method 2400. In some embodiments, method 2400 can be implemented by a computer program product, embodied in a computer-readable medium, including computer-executable instructions, such as program code, executed by computers (e.g., apparatus 400 of FIG. 4). Referring to FIG. 24, method 2400 may include the following steps 2402 to 2406.

At step 2402, encoding a flag indicating whether applying an NNIP fusion mode.

At step 2404, when the NNIP fusion mode is applied, the NNIP mode is fused with a first prediction mode, and the first prediction mode is different from the NNIP mode. The first prediction mode includes DIMD mode, including sub-modes of the DIMD mode, TIMD mode, including sub-modes of the TIMD mode, OBIC mode, etc.

At step 2406, a current block is predicted using the NNIP fusion mode.

In some embodiments, step 2404 of fusing the NNIP mode with the first prediction mode further includes fusing a predictor of the NNIP mode with a predictor of the first prediction mode to obtain a final predictor. Step 2406 of predicting the current block using the NNIP fusion mode further includes predicting the current block using the final predictor.

In some embodiments, a predictor of NNIP mode is fused with a predictor of DIMD mode, including sub-modes of DIMD mode.

For example, an NNIP predictor is fused with a DIMD predictor to obtain a final predictor, and the current block is predicted using the final predictor, and the final predictor is generated as follows:

$${Pred}_{final} = {Pred}_{NNIP} \times w + {Pred}_{DIMD} \times ( 1 - w ) \qquad ( 19 )$$

wherein the Pred_{final} is the final prediction after fusion. The Pred_{NNIP} and Pred_{DIMD} are the predictor generated by NNIP and DIMD mode (or DIMD's sub-mode), respectively, w is the fusion weight applied to NNIP predictor, and w is a fractional number.

In some embodiments, the value of w can be one of {1/8, 2/8, 3/8, 4/8, 5/8, 6/8, 7/8}.

In some embodiments, the value of w can be one of {1/16, 2/16, 3/16, 4/16, 5/16, 6/16, 7/16, 8/16, 9/16, 10/16, 11/16, 12/16, 13/16, 14/16, 15/16}.

In some embodiments, the value of w is fixed to 4/8.

In some embodiments, the fusion weight w of the NNIP fusion mode can be set based on the following template cost:

$$w = \frac{{TMCost}_{DIMD}}{{TMCost}_{DIMD} + {TMCost}_{NNIP}} \qquad ( 20 )$$

wherein TMCost_{DIMD} is the sum of absolute difference between template predictor generated by DIMD mode and neighboring reconstructed samples, TMCost_{NNIP} is the sum of absolute difference between template predictor generated by NNIP and neighboring reconstructed samples.

In some embodiments, as a sub-mode of DIMD mode, the NNIP predictor can be fused with OBIC predictor.

In some embodiments, the NNIP predictor is fused with a predictor of TID mode, including TIMID's sub-modes, and the final predictor is generated based on the following:

$${Pred}_{final} = {Pred}_{NNIP} \times w + {Pred}_{TIMD} \times ( 1 - w ) \qquad ( 21 )$$

wherein the Pred_{final} is the final prediction after fusion. The Pred_{NNIP} and Pred_{TIMD} are the predictor generated by NNIP and TIMD mode (or TIMD's sub-mode), respectively, w is the fusion weight applied to NNIP predictor, and w is a fractional number.

In some embodiments, the value of w can be one of {1/8, 2/8, 3/8, 4/8, 5/8, 6/8, 7/8}.

In some embodiments, the value of w can be one of {1/16, 2/16, 3/16, 4/16, 5/16, 6/16, 7/16, 8/16, 9/16, 10/16, 11/16, 12/16, 13/16, 14/16, 15/16}.

In some embodiments, the value of w is fixed to 4/8.

In some embodiments, the fusion weight w is set based on the following template cost:

$$w = \frac{{TMCost}_{TIMD}}{{TMCost}_{TIMD} + {TMCost}_{NNIP}} \qquad ( 22 )$$

wherein TMCost_{TIMD} is the sum of absolute difference between template predictor generated by TIMD mode and neighboring reconstructed samples, TMCost_{NNIP} is the sum of absolute difference between template predictor generated by NNIP and neighboring reconstructed samples.

In some embodiments, sub-modes of TIMD mode include TIMD-Merge mode and TIMD-SAD mode, and the NNIP predictor is fused with a predictor of TIMD-Merge mode or TIMD-SAD mode.

In some embodiments, NNIP mode is taken as an additional intra mode instead of using equivalent traditional intra mode to fuse with other modes in OBIC mode.

In some embodiments, when building the histogram of occurrence in OBIC mode, the NNIP mode is considered as an additional intra mode other than one of the exist 67 intra modes. The sample-wise occurrence of the NNIP mode is calculated the same as other 67 intra modes. If the top N (N is a positive integer, such as 5) highest occurrence modes include NNIP mode, the NNIP predictor is used and fused with other predictors derived by OBIC to generate the final OBIC predictor.

In some embodiments, the fusion weight of NNIP mode in the fusion process of OBIC mode is fixed to a fraction value w, which can be one of {1/16, 2/16, 3/16, 4/16, 5/16, 6/16, 7/16, 8/16, 9/16, 10/16, 11/16, 12/16, 13/16, 14/16, 15/16}.

In some embodiments, the fusion weight w of NNIP is set based on the following template cost:

$$w = \frac{{TMCost}_{A n g}}{{TMCost}_{A n g} + {TMCost}_{NNIP}} \qquad ( 23 )$$

wherein TMCost_{Ang} is the sum of absolute difference between template predictor generated by other modes derived by OBIC excluding NNIP and neighboring reconstructed samples, TMCost_{NNIP} is the sum of absolute difference between template predictor generated by NNIP and neighboring reconstructed samples.

In some embodiments, the NNIP mode is used in a fusion process of the first prediction mode and the first prediction mode is different from the NNIP mode. For example, step 2404 of fusing the NNIP mode with the first prediction mode further includes replacing one mode of the first prediction mode with the NNIP mode in a fusion process of the first prediction mode to generation a final predictor. Step 2406 of predicting the current block using the NNIP fusion mode further includes predicting the current block using the final predictor.

In some embodiments, the NNIP mode is used in the fusion process of DIMD mode and its sub-modes.

In some embodiments, the planar mode is replaced with the NNIP mode in the DIMD fusion process to generate final predictor for DIMD. The NNIP fusion weight is fixed to be one of {1/16, 2/16, 3/16, 4/16, 5/16, 6/16, 7/16, 8/16, 9/16, 10/16, 11/16, 12/16, 13/16, 14/16, 15/16}.

In some embodiments, the non-angular mode (planar or block vector-based) is replaced with the NNIP mode in the DIMD fusion process to generate final predictor for DIMD. The NNIP fusion weight is fixed to be one of {1/16, 2/16, 3/16, 4/16, 5/16, 6/16, 7/16, 8/16, 9/16, 10/16, 11/16, 12/16, 13/16, 14/16, 15/16}.

In some embodiments, a sub-mode of DIMD mode includes OBIC mode, and the NNIP predictor is fused with the OBIC predictor.

In some embodiments, the NNIP mode is used in the fusion process of TIMD mode and its sub-modes.

In some embodiments, the non-angular mode (non-angular mode is fixed to planar mode in current ECM) is replaced with NNIP mode to generate the final predictor of TIMD. The non-angular mode is conditionally fused with angular mode in current TIMD, thus the NNIP mode is also conditionally fused with angular mode. The non-angular mode will be replaced by NNIP mode in the TIMD fusion process, and the NNIP fusion weight is the same as the weight of the non-angular mode in the current design.

In some embodiments, the non-angular mode is replaced with NNIP mode in the TID fusion process, and the NNIP fusion weight is fixed to be one of {1/16, 2/16, 3/16, 4/16, 5/16, 6/16, 7/16, 8/16, 9/16, 10/16, 11/16, 12/16, 13/16, 14/16, 15/16}.

In some embodiments, the angular mode is always fused with the NNIP mode in TIMD fusion process, and the fusion weight is fixed to be one of {1/16, 2/16, 3/16, 4/16, 5/16, 6/16, 7/16, 8/16, 9/16, 10/16, 11/16, 12/16, 13/16, 14/16, 15/16}.

In some embodiments, sub-modes of TIMD mode include TIMD-Merge mode and TIMD-SAD mode, and the NNIP predictor is fused with a predictor of TIMD-Merge mode or TIMD-SAD mode.

Embodiments of the present disclosure further provide method for extending NNIP to other modes.

In current ECM, the intra predictor in GPM with inter and intra prediction is selected from three intra prediction mode (IPM) candidates without NNIP mode.

In some embodiments, NNIP mode is added into IPM candidates list for GPM with inter and intra prediction mode and its extension modes.

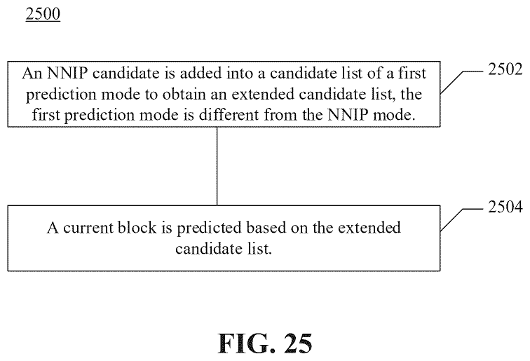

FIG. 25 is a flowchart of an exemplary method for extending NNIP to other prediction modes, according to some embodiments of the present disclosure. Method 2500 can be performed by an encoder (e.g., by process 200A of FIG. 2A or 200B of FIG. 2B), performed by a decoder (e.g., by process 300A of FIG. 3A or 300B of FIG. 3B), or performed by one or more software or hardware components of an apparatus (e.g., apparatus 400 of FIG. 4). For example, a processor (e.g., processor 402 of FIG. 4) can perform method 2500. In some embodiments, method 2500 can be implemented by a computer program product, embodied in a computer-readable medium, including computer-executable instructions, such as program code, executed by computers (e.g., apparatus 400 of FIG. 4). Referring to FIG. 25, method 2500 may include the following steps 2502 and 2504.

At step 2502, an NNIP candidate is added into a candidate list of a first prediction mode to obtain an extended candidate list, the first prediction mode is different from the NNIP mode. In some embodiments, the first prediction mode includes GPM, SGPM, and CIP mode. The NNIP candidate is obtained by NNIP mode.

At step 2504, a current block is predicted based on the extended candidate list.

In some embodiments, the first prediction mode is GPM with inter and intra prediction mode. In one example, the NNIP candidate is added into an IPM candidates list as the fourth candidate, and the maximum intra mode index is changed from 3 to 4 for signaling. In another example, one of the current three IPM candidates is replaced with the NNIP candidate, and the current IPM candidates list construction process remains unchanged. As a result, one of the final three candidates can be replaced by NNIP mode.

In some embodiments, the NNIP mode is inserted into the IPM candidates list. For example, in the intra candidates list construction process, the NNIP candidate can be inserted at any position of the list and the first of the three IPM candidates are retained for the final IPM candidates list for GPM with inter and intra prediction mode.

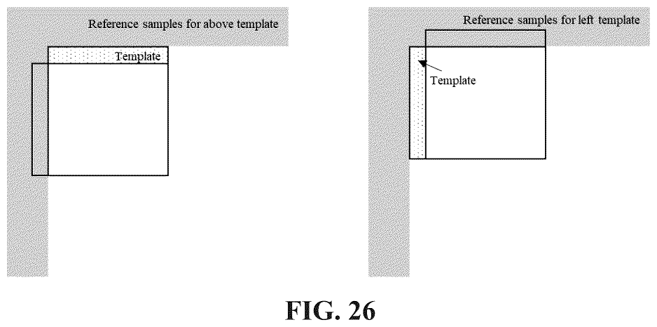

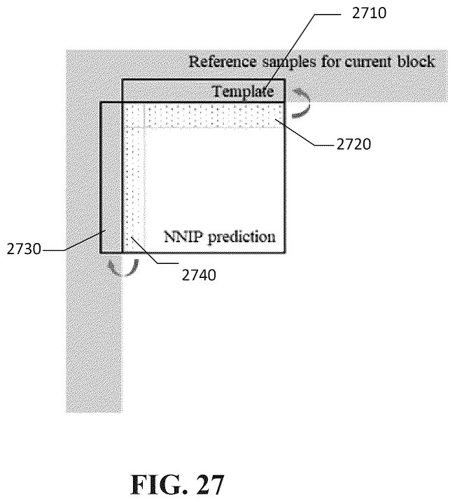

In some embodiments, considering compatibility with template-based split mode reordering of GPM with inter and intra prediction mode, a template prediction for the NNIP candidate is performed. In some embodiments, the neural network-based prediction is performed on the template for NNIP candidates. FIG. 26 illustrates exemplary template prediction for NNIP mode, according to some embodiments of the present disclosure. As shown in FIG. 26, template prediction is performed by fetching reference samples of template as neural network's input to generate template prediction results. In some embodiments, the prediction result of the current block is used to approximate the 1-line template prediction result for NNIP candidate. FIG. 27 illustrates exemplary template prediction of NNIP using approximate method, according to some embodiments of the present disclosure. As shown in FIG. 27, the template prediction is approximated by the prediction result of the current block. Specifically, the prediction samples of the above template 2710 are obtained by flipping the prediction samples of the current block according to the upper edge 2720, and the prediction samples of the left template 2730 are obtained by flipping the prediction samples of the current block according to the left edge 2740. In some embodiments, the intra mode is derived by performing a DIMD process on the samples predicted using the NNIP mode. Then, the template prediction for NNIP candidates is performed using the derived intra mode. In some embodiments, the planar mode is used to perform template prediction for NNIP candidates.

In some embodiments, for regression-based extension of GPM with inter and intra prediction mode, an NNIP candidate (if it is available) is attempt to be added into the IPM candidates list at any order for IPM candidates list derivation. For example, the NNIP candidate is checked secondly while the first checked candidate is not available, thus the NNIP candidate is located at the first place in the final list. Therefore, the length of the IPM candidates list doesn't change. For another example, the NNIP candidate is checked fourthly while the IPM candidate list with a length of 3 is fully added, thus the NNIP candidate is not added to the final list. In some embodiments, the NNIP candidate (if it is available) is always added to the IPM candidates list at any position. The signaling overhead increases, and the total index number is increased by 1.

In some embodiments, the first prediction mode is SGPM mode, and the NNIP mode is added into candidates list for SGPM mode and its extension modes.

For example, the NNIP mode along with existing up to three IPM candidates and up to 6 block vector-based candidates are added to form the final candidate list of SGPM.

In some embodiments, considering compatibility with template-based reordering of SGPM mode, a template prediction for the NNIP candidate is performed. In some embodiments, the neural network-based prediction is performed on the template for the NNIP candidate. Referring back to FIG. 26, template prediction is performed by fetching reference samples of template as neural network's input to generate template prediction results. In some embodiments, the prediction result of the current block is used to approximate the template prediction result for the NNIP candidate. Referring back to FIG. 27, the template prediction is approximated by the prediction result of the current block. Specifically, the prediction samples of the above template 2710 are obtained by flipping the prediction samples of the current block according to the upper edge 2720, and the prediction samples of the left template 2730 are obtained by flipping the prediction samples of the current block according to the left edge 2740. In some embodiments, the intra mode is derived by performing a DIMD process on the samples predicted using the NNIP mode. Then, the template prediction for NNIP candidates is performed using the derived intra mode. In some embodiments, the planar mode is used to perform template prediction for NNIP candidates.

In some embodiments, for regression-based extension of SGPM mode, an NNIP candidate is inserted into the IPM candidates list at any position and the length of the IPM candidates list doesn't change. In some embodiments, the NNIP candidate is always added to the IPM candidates list at any position. The signaling overhead increases, and the total index number is increased by 1.

In current ECM, the intra predictor in CIIP is fixed to the intra mode derived from TIMD process.

Embodiments of the present disclosure provide methods for using a predictor obtained by NNIP mode as the intra predictor of CIP mode.

In some embodiments, the angular mode derived from the TIMD process can be replaced by NNIP mode and the inter predictor of the CIIP keeps the same. The inter predictor of the CIIP can be obtained by regular merge mode, affine merge mode, SbTMVP mode, or TM merge mode.

In some embodiments, when the inter predictor of the CIP is obtained by any one of {regular merge mode, affine merge mode, SbTMVP mode, TM merge mode}, the angular mode derived from the TIMD process can be replaced by NNIP mode, i.e., the intra predictor is replaced by the predictor obtained by the NNIP mode. In this example, whether the inter predictor of the CIP is obtained by a first prediction mode is determined. If the inter predictor of the CIIP is obtained by the first prediction mode, the angular mode derived from the TIMD process is replaced by NNIP mode, and the intra predictor of the CIIP is obtained by the NNIP mode. If the inter predictor of the CIIP is not obtained by the first prediction mode, the angular mode derived from the TIMD process is not replaced by NNIP mode, i.e., the angular mode keeps deriving from the TIMD process and the intra predictor is not replaced. The first prediction mode is select from one of regular merge mode, affine merge mode, SbTMVP mode, or TM merge mode. For example, in one example, only when the inter predictor of the CIP is obtained by regular merge mode, the angular mode derived from the TIMD process can be replaced by NNIP mode and the intra predictor is obtained by NNIP mode. If the inter predictor of the CIIP is obtained by affine merge mode, SbTMVP mode, or TM merge mode, the angular mode derived from the TIMD process is not replaced by NNIP mode, i.e., the angular mode keeps deriving from the TIMD process. In another example, only when the inter predictor of the CIIP is obtained by affine merge mode, the angular mode derived from the TIMD process can be replaced by NNIP mode and the intra predictor is obtained by NNIP mode. If the inter predictor of the CIP is obtained by regular merge mode, SbTMVP mode, or TM merge mode, the angular mode derived from the TIMD process is not replaced by NNIP mode, i.e., the angular mode keeps deriving from the TIMD process.

In some embodiments when the inter predictor of the CIP is obtained by any two of {regular merge mode, affine merge mode, SbTMVP mode, TM merge mode}, the angular mode derived from the TIMD process can be replaced by NNIP mode and the intra predictor is obtained by NNIP mode. In this example, whether the inter predictor of the CIIP is obtained by a first prediction mode or a second prediction mode is determined. If the inter predictor of the CIIP is obtained from the first prediction mode or the second prediction mode, the angular mode derived from the TIMD process is replaced by NNIP mode and the intra predictor is obtained by NNIP mode. If the inter predictor of the CIIP is not obtained from the first prediction mode nor the second prediction mode, the angular mode derived from the TIMD process is not replaced by NNIP mode, i.e., the angular mode keeps deriving from the TIMD process. The first prediction mode and the second prediction mode are select from two of regular merge mode, affine merge mode, SbTMVP mode, or TM merge mode. For example, in one example, the first prediction mode and the second prediction mode are affine merge mode and SbTMVP mode. In another example, the first prediction mode and the second prediction mode are SbTMVP mode and TM merge mode.

In some embodiments, when the inter predictor of the CIP is obtained from any three of {regular merge mode, affine merge mode, SbTMVP mode, TM merge mode}, the angular mode derived from the TIMD process can be replaced by NNIP mode. In this example, whether the inter predictor of the CIIP is obtained by a first prediction mode, a second prediction mode, or a third prediction mode is determined. If the inter predictor of the CIP is obtained by the first prediction mode, the second prediction mode, or the third prediction mode, the angular mode derived from the TIMD process is replaced by NNIP mode and the intra predictor is obtained by NNIP mode. If the inter predictor of the CIP is not obtained by the first prediction mode, the second prediction mode, nor the third prediction mode, the angular mode derived from the TIMD process is not replaced by NNIP mode, i.e., the angular mode keeps deriving from the TIMD process. The first prediction mode, the second prediction mode, and the third prediction mode are selected from three of regular merge mode, affine merge mode, SbTMVP mode, or TM merge mode. For example, in one example, the first prediction mode, the second prediction mode, and the third prediction mode are regular merge mode, affine merge mode and SbTMVP mode. In another example, the first prediction mode, the second prediction mode, and the third prediction mode are regular merge mode, SbTMVP mode, and TM merge mode.

In some embodiments, the intra predictor of the CIP is fixed to obtained by NNIP mode and can be signaled as a new mode. In this example, a flag is signaled to indicate whether the intra predictor of the CIIP is obtained by NNIP mode.

Embodiments of the present disclosure provide methods for CIIP weight modification.

To modify the intra-inter weights of the CIIP for higher coding efficiency, an angular-wise weight is proposed. In some embodiments, the angular-wise weight of the CIIP mode is changed from sub-block level to pixel level and the weights.

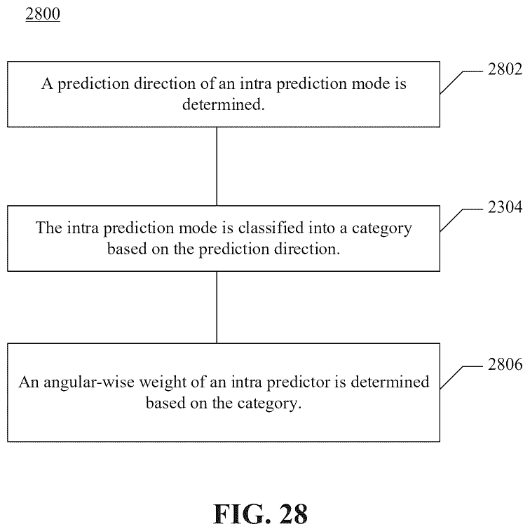

FIG. 28 is a flowchart of an exemplary method for determining an angular-wise weight for a CIP mode, according to some embodiments of the present disclosure. Method 2400 can be performed by an encoder (e.g., by process 200A of FIG. 2A or 200B of FIG. 2B), performed by a decoder (e.g., by process 300A of FIG. 3A or 300B of FIG. 3B), or performed by one or more software or hardware components of an apparatus (e.g., apparatus 400 of FIG. 4). For example, a processor (e.g., processor 402 of FIG. 4) can perform method 2800. In some embodiments, method 2800 can be implemented by a computer program product, embodied in a computer-readable medium, including computer-executable instructions, such as program code, executed by computers (e.g., apparatus 400 of FIG. 4). Referring to FIG. 28, method 2800 may include the following steps 2802 to 2806.

At step 2802, a prediction direction of an intra prediction mode is determined.

At step 2804, the intra prediction mode is classified into a category based on the prediction direction. In some embodiments, based on the prediction direction, the angular intra modes are divided into three categories: near horizontal modes, near vertical modes, and near diagonal modes. For near horizontal modes, the pixel level weight of the intra part gradually changes linearly along the horizontal direction, with the left edge of the block having the highest weight and the right edge of the block having the lowest weight. For near vertical modes, the pixel level weight of the intra part gradually changes linearly along the vertical direction, with the upper edge of the block having the highest weight and the lower edge of the block having the lowest weight. For near diagonal modes, the pixel level weight of the intra part gradually changes linearly along the diagonal direction of the current block, with the highest weight in the upper left corner of the block and the lowest weight in the lower right corner of the block. Therefore, one intra mode can be classified into a category of the three categories based on the prediction direction of the intra mode. In some embodiments, the range of these three categories varies depending on the block size and can be determined as Table 4.

TABLE 4
The intra mode scopes of three categories for different block sizes.

| Width/Height | Near-horizontal | Near-diagonal | Near-vertical |
|---|---|---|---|
| 1 | [2, 28) | [28, 40] | (40, 66] |
| 2 | [2, 24) | [24, 40] | (40, 66] |
| 4 | [2, 22) | [22, 40] | (40, 66] |
| 8 | [2, 20) | [20, 40] | (40, 66] |
| 16 | [2, 19) | [19, 40] | (40, 66] |
| 1/2 | [2, 28) | [28, 44] | (44, 66] |
| 1/4 | [2, 28) | [28, 46] | (46, 66] |
| 1/8 | [2, 28) | [28, 48] | (48, 66] |
| 1/16 | [2, 28) | [28, 49] | (49, 66] |

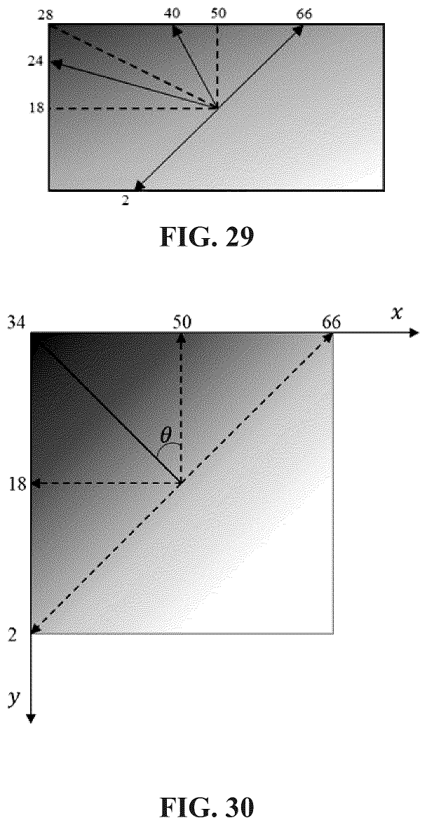

FIG. 29 illustrates exemplary three categories for block with width/height equals to 2, according to some embodiments of the present disclosure. As shown in FIG. 29 and referring to Table. 4, for width/height being to 2, the dashed lines represent the horizontal (angular mode 18), vertical (angular mode 50), and diagonal (angular mode 32) directions of the block, respectively. The boundary angular mode between near diagonal and near horizontal is mode 24, and the boundary angular mode between near vertical and near diagonal is mode 40. In this example, for angular mode indexes between [2, 24). An intra mode inter n refers to an angular mode having an angular mode index being n, wherein n is in a range of 2 to 66.

In some embodiments, the scope of these three categories varies depending on the block size can be determined as Table 5.

TABLE 5
The intra mode scopes of three categories for different
block sizes in another example.

| Width/Height | Near-horizontal | Near-diagonal | Near-vertical |
|---|---|---|---|
| 1 | [2, 28) | [28, 40] | (40, 66] |
| 2 | [2, 24) | [24, 34] | (34, 66] |
| 4 | [2, 22) | [22, 28] | (28, 66] |
| 8 | [2, 20) | [20, 24] | (24, 66] |
| 16 | [2, 19) | [19, 22] | (22, 66] |
| 1/2 | [2, 34) | [34, 44] | (44, 66] |
| 1/4 | [2, 40) | [40, 46] | (46, 66] |
| 1/8 | [2, 44) | [44, 48] | (48, 66] |
| 1/16 | [2, 46) | [46, 49] | (49, 66] |

Referring back to FIG. 28, at step 2806, an angular-wise weight of an intra predictor is determined based on the category. For example, the angular-wise weight of the intra predictor can be determined as:

$${w}_{intra} = \{ \begin{matrix}\frac{( width - x ) \cdot 64 + 32}{width} - 4 , & for near horizontal modes \\ \frac{\begin{matrix}( 2 \cdot width \cdot height - x \cdot \\ height - y \cdot width ) \cdot 64 + 32\end{matrix}}{2 \cdot width \cdot height} - 4 , & for near diagonal modes \\ \frac{( height - y ) \cdot 64 + 32}{height} - 4 , & for near vertical modes\end{matrix} . \qquad ( 24 )$$

where the wᵢₙₜᵣₐ is clipped to within [4, 60], and the weight for the inter predictor wᵢₙₜₑᵣ is based on the following:

$${w}_{inter} = 64 - {w}_{intra} \qquad ( 25 )$$

In some embodiments, an angular-wise weight used for CIP is a pixel level weight, where the weight is position dependent, and the pixel level angular-wise weights of the intra predictor gradually change linearly along the intra angular direction.

For example, the pixel level angular-wise weight of the intra predictor Wᵢₙₜᵣₐ is determined by each of the angular mode. The Wᵢₙₜᵣₐ can be formulated based on the following:

$${w}_{intra} = A x + B y + C \qquad ( 26 )$$

where the (x, y) is the sample position of the current block (x within [0, width−1] and y within [0, height−1]).

According to Function 26, the weight Wᵢₙₜᵣₐ decreases linearly along the direction of angle prediction on the two-dimensional image plane and reaches its maximum or minimum value at the boundary of a coding block. FIG. 30 illustrates exemplary angle between two angle modes for a pixel, according to some embodiments of the present disclosure. As shown in FIG. 30, for a pixel, the diagonal mode corresponds to mode 34, and taking the angular mode 34 as an example, the angle between mode 34 and the vertical mode 50 is 0. For different modes, the A, B, and C are determined based on different constraints and functions.

For angular mode index within [2, 18), the angle between each mode and the horizontal mode 18 is θ. The relationship between A, B, and θ can be obtained as

$$\frac{A}{B} = - \frac{1}{tan θ} .$$

Besides, wᵢₙₜᵣₐ reaches its maximum value wMax when x=0 and y=height−1. wᵢₙₜᵣₐ reaches its minimum value w Min when x=width−1 and y=0. Finally, A, B, and C can be determined as Function 27 based on these constraints:

$$\{ \begin{matrix}A = \frac{- k \cdot ( w Max - w Min )}{k \cdot ( w - 1 ) - ( h - 1 )} \\ B = \frac{- ( w Max - w Min )}{k \cdot ( w - 1 ) - ( h - 1 )} \\ C = \frac{w Max \cdot k \cdot ( w - 1 ) - ( h - 1 ) \cdot w Min}{k \cdot ( w - 1 ) - ( h - 1 )} \\ k = - \frac{abs InvAng}{512}\end{matrix} \qquad ( 27 )$$

where wMax is a positive integer, such as 64, indicating the maximum weight of the intra part and w Min is a non-negative integer, such as 0, indicating the minimum weight of the intra part.

For angular mode index within (18, 34), the angle between each mode and the horizontal mode 18 is θ. The relationship between A, B, and θ can be obtained as

$$\frac{A}{B} = \frac{1}{tan θ} .$$

Besides, wᵢₙₜᵣₐ reaches its maximum value wMax when x=0 and y=0. wᵢₙₜᵣₐ reaches its minimum value w Min when x=width−1 and y=height−1. Finally, A, B and C can be determined as Function 28 based on these constrains. Specifically, for the case of intra mode 18,

$${w}_{intra} = \frac{w Min - w Max}{w - 1} \cdot x + w Max .$$

$$\{ \begin{matrix}A = \frac{- k \cdot ( w Max - w Min )}{k \cdot ( w - 1 ) - ( h - 1 )} \\ B = \frac{- ( w Max - w Min )}{k \cdot ( w - 1 ) - ( h - 1 )} \\ C = \frac{w Max \cdot k \cdot ( w - 1 ) - ( h - 1 ) \cdot w Min}{k \cdot ( w - 1 ) - ( h - 1 )} \\ k = - \frac{abs InvAng}{512}\end{matrix} \qquad ( 28 )$$

For angular mode index within [34, 50), the angle between each mode and the vertical mode 50 is 0. The relationship between A, B, and θ can be obtained as A/B=tan θ. Besides, Wᵢₙₜᵣₐ reaches its maximum value wMax when x=0 and y=0. wᵢₙₜᵣₐ reaches its minimum value w Min when x=width−1 and y=height−1. Finally, A, B and C can be determined as Function 29 based on these constraints:

$$\{ \begin{matrix}A = \frac{- k \cdot ( w Max - w Min )}{k \cdot ( w - 1 ) + ( h - 1 )} \\ B = \frac{- ( w Max - w Min )}{k \cdot ( w - 1 ) + ( h - 1 )} \\ C = w Max \\ k = \frac{abs Ang}{32}\end{matrix} \qquad ( 29 )$$

For angular mode index within (50, 66], the angle between each mode and the vertical mode 50 is θ. The relationship between A, B, and θ can be obtained as

$$\frac{A}{B} = - tan θ .$$

Besides, wᵢₙₜᵣₐ reaches its maximum value wMax when x=width−1 and y=0. wᵢₙₜᵣₐ reaches its minimum value w Min when x=0 and y=height−1. Finally, A, B and C can be determined as Function (30) based on these constrains. Specifically, for the case of intra mode 50,

$${w}_{intra} = \frac{w Min - w Max}{h - 1} \cdot y + w Max .$$

$$\{ \begin{matrix}A = \frac{k \cdot ( w Max - w Min )}{k \cdot ( w - 1 ) - ( h - 1 )} \\ B = \frac{( w Max - w Min )}{k \cdot ( w - 1 ) - ( h - 1 )} \\ C = \frac{w Min \cdot k \cdot ( w - 1 ) - ( h - 1 ) \cdot w Max}{k \cdot ( w - 1 ) - ( h - 1 )} \\ k = - \frac{abs Ang}{32}\end{matrix} \qquad ( 30 )$$

In the Functions (27) to (30), the absInvAng

$$( equals to \frac{1}{tan θ} << 9 )$$

and absAng (equals to tan θ<<5) are approximated as integers as Table 6.

TABLE 6
The offset value absInvAng and absAng of each angular mode.

| absAngMode | 0 | 1 | 2 | 3 | 4 | 5 | 6 | 7 | 8 |
|---|---|---|---|---|---|---|---|---|---|
| absAng | 0 | 1 | 2 | 3 | 4 | 6 | 8 | 10 | 12 |
| absInvAng | 0 | 16384 | 8192 | 5461 | 4096 | 2731 | 2048 | 1638 | 1365 |

| absAngMode | 9 | 10 | 11 | 12 | 13 | 14 | 15 | 16 |
|---|---|---|---|---|---|---|---|---|
| absAng | 14 | 16 | 18 | 20 | 23 | 26 | 29 | 32 |
| absInvAng | 1170 | 1024 | 910 | 819 | 712 | 630 | 565 | 512 |

The absAngMode is calculated as: absAngMode=abs(iMode>=32 ?(iMode−50):(iMode−18)), and the iMode is the intra mode index.

In some embodiments, if NNIP mode is used as the intra prediction mode in CIP, the equivalent angular mode can be derived according to DIMD process. Then, the equivalent angular mode can be used to determine the angular-wise intra weight.

In some embodiments, the angular-wise weight can be used when the inter part of the CIIP is not affine merge mode or SbTMVP mode.

The embodiments described in the present disclosure can be freely combined.

In some embodiments, a non-transitory computer readable medium storing a bitstream is provided. The bitstream is generated by receiving a video sequence and encoding the video sequence to generate coded information included in the bitstream. The bitstream can be transmitted to a decoder for decoding. The video sequence is encoded by the above-described methods.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

The embodiments may further be described using the following clauses:
1. A method for encoding a video sequence, the method comprising:
receiving a video sequence; and
encoding the video sequence by:
   determining a block size of a block;
   determining whether the block size is included in a first list;
   in response to the block size is not included in the first list, determining whether the block size is included in a second list;
   in response to the block size is included in the second list, selecting a neural network model for the block size and performing downsampling on the block based on the block size and the neural network model; and
   performing a neural network-based intra prediction (NNIP) on the block using the neural network model.
2. The method according to clause 1, wherein before performing downsampling on the block based on the block size, the encoding further comprises:
   performing transpose transformation on the block.
3. The method according to clause 1, wherein the first list comprises block sizes of {4×4, 8×4, 4×8, 16×4, 4×16, 32×4, 4×32, 8×8, 16×8, 8×16, 32×8, 8×32, 16×16, 32×16, 16×32, 32×32, 64×64}.
4. The method according to clause 3, wherein the second list comprises block sizes of {64×8, 8×64, 64×16, 16×64, 64×32, 32×64}.
5. The method according to clause 4, wherein the neural network model is selected from a 16×4 neural network model, a 16×8 neural network model, and a 16×16 neural network model.
6. The method according to clause 1, wherein selecting the neural network model comprises selecting the neural network model based on at least one of: a width-to-height ratio of the block; a downsampling factor along a width direction or a height direction; or whether transpose transformation is performed prior to downsampling.
7. The method according to clause 1, further comprising:
storing a bitstream that is generated based on the encoding.
8. A method for encoding a video sequence, the method comprising:
receiving a video sequence; and
encoding the video sequence by:
   encoding a flag indicating whether to apply a neural network-based intra prediction (NNIP) fusion mode; and
   in response to the flag indicating the NNIP fusion mode is applied, fusing the NNIP mode with a first prediction mode, wherein the first prediction mode is different from the NNIP mode; and
   predicting a current block using the NNIP fusion mode.
9. The method according to clause 8, wherein the first prediction mode comprises one of a decoder-side intra mode derivation (DIMD) mode, an occurrence-based intra coding (OBIC) mode, a template-based intra mode derivation (TIMD) mode, TIMD-Merge mode, or TIMD-sum of absolute difference (SAD) mode.
10. The method according to clause 9, wherein fusing the NNIP mode with the first prediction mode further comprises:
   fusing a predictor of the NNIP mode with a predictor of the first prediction mode to generate a final predictor; and
predicting the current block using the NNIP fusion mode comprises:
   predicting the current block using the final predictor.
11. The method according to clause 10, wherein the final predictor is obtained by weighted sum of the predictor of the NNIP mode and the predictor of the first prediction mode.
12. The method according to clause 11, wherein a weight for the weighted sum is determined based template matching (TM) costs of the NNIP mode and the first prediction mode.
13. The method according to clause 11, wherein a weigh for the weighted sum is one of {1/8, 2/8, 3/8, 4/8, 5/8, 6/8, 7/8}; one of {1/16, 2/16, 3/16, 4/16, 5/16, 6/16, 7/16, 8/16, 9/16, 10/16, 11/16, 12/16, 13/16, 14/16, 15/16}; or 4/8.
14. The method according to clause 11, wherein the first predictor mode is the OBIC mode, and fusing the NNIP mode with the prediction mode further comprises:
   calculating sample-wise occurrence of the NNIP mode; and
   in response to the NNIP mode being included in top N highest occurrence modes, obtaining the final predictor by weighted sum of the predictor of the NNIP mode and the predictor of the OBIC mode, wherein N is a positive integer.
15. The method according to clause 9, wherein fusing the NNIP mode with the first prediction mode further comprises:
replacing a mode used in the first prediction mode with the NNIP mode in a fusion process of the first prediction mode to generate a final predictor; and
predicting the current block using the NNIP fusion mode comprises:
   predicting the current block using the final predictor.
16. The method according to clause 15, wherein the first prediction mode is the DIMD mode, and a non-angular mode in the DIMD mode is replaced by the NNIP mode.
17. The method according to clause 16, wherein the non-angular mode is a planar mode.
18. The method according to clause 16, wherein the non-angular mode is a planar mode or a block vector-based mode.
19. The method according to clause 16, wherein a weight for the NNIP mode in the fusing process of the DIMD mode is fixed to be one of {1/16, 2/16, 3/16, 4/16, 5/16, 6/16, 7/16, 8/16, 9/16, 10/16, 11/16, 12/16, 13/16, 14/16, 15/16}.
20. The method according to clause 15, wherein the first prediction mode is the TIMD mode, and a non-angular mode in the TIMD mode is replaced by the NNIP mode.
21. The method according to clause 20, wherein the non-angular mode is a planar mode.
22. The method according to clause 21, wherein a weight for the NNIP mode in the fusing process of the TIMD mode is fixed to be one of {1/16, 2/16, 3/16, 4/16, 5/16, 6/16, 7/16, 8/16, 9/16, 10/16, 11/16, 12/16, 13/16, 14/16, 15/16}.
23. The method according to clause 9, wherein the first prediction mode is the TIMD mode, and fusing the NNIP mode with the first prediction mode further comprises:
fusing the NNIP mode with angular modes in a fusion process of the TIMD mode to generate a final predictor; and
predicting the current block using the NNIP fusion mode comprises:
   predicting the current block using the final predictor.
24. A method for encoding a video sequence, the method comprising:
receiving a video sequence; and
encoding the video sequence by:
   adding a neural network-based intra prediction (NNIP) candidate into a candidate list of a first prediction mode to obtain an extended candidate list, wherein the first prediction mode is different from a NNIP mode; and
   predicting a current block based on the extended candidate list.
25. The method according to clause 24, wherein the first prediction mode is a geometric partition mode (GPM) with inter and intra mode or a spatial geometric partition mode (SGPM).
26. The method according to clause 25, wherein the first prediction mode is the GPM with inter and intra mode, and adding the NNIP candidate into a candidate list of a first prediction mode to obtain the extended candidate list further comprises at least one of:
   adding the NNIP candidate into an intra prediction mode (IPM) candidates list, and setting a value of a maximum intra mode index to be 4;
   replacing one IPM candidate in an IPM candidates list with the NNIP candidate; or
   inserting the NNIP candidate into an IPM candidates list, and obtaining a final IPM candidates list with first three candidates in the IPM candidate list.
27. The method according to clause 25, wherein the first prediction mode is the GPM with inter and intra mode or the SGPM, and a template-based split mode reordering is performed on the first prediction mode, the encoding further comprises:
   performing a template prediction for the NNIP candidate.
28. The method according to clause 27, wherein performing the template prediction for the NNIP candidate further comprises:
   performing a neural network-based prediction on a template for the NNIP candidate.
29. The method according to clause 28, wherein performing the neural network-based prediction on the template for the NNIP candidate further comprises:
   fetching reference samples of the template as a neural network's input to generate a template prediction result for the NNIP candidate.
30. The method according to clause 27, wherein performing the template prediction for the NNIP candidate further comprises:
   using a prediction result of the current block to approximate a template prediction result for the NNIP candidate.
31. The method according to clause 27, wherein performing the template prediction for the NNIP candidate further comprises:
   deriving an intra mode by performing a decoder-side intra mode derivation (DIMD) mode process on samples predicted using the NNIP mode; and
   performing the template prediction for the NNIP candidate using the intra mode.
32. The method according to clause 27, wherein performing the template prediction for the NNIP candidate further comprises:
   performing the template prediction using a planar mode.
33. The method according to clause 25, wherein the first prediction mode is a GPM with inter and intra prediction mode or the SGPM, and a regression-based extension is performed on the first prediction mode, adding the NNIP candidate into a candidate list of a first prediction mode to obtain the extended candidate list further comprises:
   inserting the NNIP candidate into an IPM candidate list.
34. The method according to clause 33, wherein the encoding further comprises:
   increasing a total index number by 1.
35. The method according to clause 25, wherein the first prediction mode is the SGPM, and adding the NNIP candidate into a candidate list of a first prediction mode to obtain the extended candidate list further comprises:
   adding the NNIP candidate, three IPM candidates, and 6 block vector-base candidates to obtain the extend candidate list.
36. A method for encoding a video sequence, the method comprising:
receiving a video sequence; and
encoding the video sequence by:
   obtaining an intra predictor by a neural network-based intra prediction (NNIP) mode;
   obtaining a final predictor of a combined inter and intra prediction (CIIP) mode based on the intra predictor and an inter predictor; and
   predicting a current block using the final predictor.
37. The method according to clause 36, wherein the inter predictor is obtained by one of a regular merge mode, an affine merge mode, a subblock-based temporal motion vector prediction (SbTMVP) mode, or a template matching (TM) merge mode.
38. The method according to clause 36, wherein the encoding further comprises:
   determining whether the inter predictor being obtained by a first prediction mode;
   in response to the inter predictor being obtained by the first prediction mode, obtaining the intra predictor by the NNIP mode; wherein the first prediction mode is one of a regular merge mode, an affine merge mode, a subblock-based temporal motion vector prediction (SbTMVP) mode, or a template matching (TM) merge mode.
39. The method according to clause 36, wherein the encoding further comprises:
   determining whether the inter predictor being obtained by a first prediction mode or a second prediction mode;
   in response to the inter predictor being obtained by the first prediction mode or the second prediction mode, obtaining the intra predictor by the NNIP mode; wherein the first prediction mode and the second prediction mode are any two of a regular merge mode, an affine merge mode, a subblock-based temporal motion vector prediction (SbTMVP) mode, or a template matching (TM) merge mode.
40. The method according to clause 36, wherein the encoding further comprises:
   determining whether the inter predictor being obtained by a first prediction mode, a second prediction mode, or a third prediction mode;
   in response to the inter predictor being obtained by the first prediction mode, the second prediction mode, or the third prediction mode, obtaining the intra predictor by the NNIP mode; wherein the first prediction mode, the second prediction mode, and the third prediction mode are any three of a regular merge mode, an affine merge mode, a subblock-based temporal motion vector prediction (SbTMVP) mode, or a template matching (TM) merge mode.
41. A method for encoding a video sequence, the method comprising:
receiving a video sequence; and
encoding the video sequence by:
   determining an angular-wise weight for a combined inter and intra prediction (CIIP) mode;
   obtaining a final predictor of the CIIP mode based on the angular-wise weight; and
   predicting a current block using the final predictor.
42. The method according to clause 41, wherein determining the angular-wise weight for the CIIP mode further comprises:
   determining a prediction direction of an intra prediction mode of the CIIP mode;
   classifying the intra prediction mode into a category based on the prediction direction; and
   determining the angular-wise weight based on the category.
43. The method according to clause 41, wherein classifying the intra prediction mode into a category based on the prediction direction further comprises:
classifying the intra prediction mode into one category of three categories based on the prediction direction and a block size, wherein the three categories comprise near horizontal modes, near vertical modes, and near diagonal modes.
44. The method according to clause 43, wherein the angular-wise weight is a pixel level weight.
45. The method according to clause 41, wherein the encoding further comprises:
   determining an inter prediction mode for an inter predictor of the CIP mode; and
   in response to the inter prediction mode is not an affine merge mode or a subblock-based temporal motion vector prediction (SbTMVP) mode, determining the angular-wise weight for the CIP mode.
46. The method according to clause 42, wherein a neural network-based intra prediction (NNIP) mode is applied for an intra prediction, and the intra prediction mode is an equivalent angular mode of the NNIP mode.
47. A method for decoding a bitstream, the method comprising:
receiving a bitstream; and
decoding the bitstream to generate a video sequence, the decoding comprising:
   determining a block size of a block;
   determining whether the block size is included in a first list;
   in response to the block size is not included in the first list, determining whether the block size is included in a second list;
   in response to the block size is included in the second list, selecting a neural network model for the block size and performing downsampling on the block based on the block size and the neural network model; and
   performing a neural network-based intra prediction (NNIP) on the block using the neural network model.
48. The method according to clause 47, wherein before performing downsampling on the block based on the block size, the decoding further comprises:
   performing transpose transformation on the block.
49. The method according to clause 47, wherein the first list comprises block sizes of {4×4, 8×4, 4×8, 16×4, 4×16, 32×4, 4×32, 8×8, 16×8, 8×16, 32×8, 8×32, 16×16, 32×16, 16×32, 32×32, 64×64}.
50. The method according to clause 49, wherein the second list comprises block sizes of {64×8, 8×64, 64×16, 16×64, 64×32, 32×64}.
51. The method according to clause 50, wherein the neural network model is selected from a 16×4 neural network model, a 16×8 neural network model, and a 16×16 neural network model.
52. The method according to clause 47, wherein selecting the neural network model comprises selecting the neural network model based on at least one of: a width-to-height ratio of the block; a downsampling factor along a width direction or a height direction; or whether transpose transformation is performed prior to downsampling.
53. A method for signaling a bitstream, the method comprising:
receiving a video sequence;
encoding the video sequence by:
   determining a block size of a block;
   determining whether the block size is included in a first list;
   in response to the block size is not included in the first list, determining whether the block size is included in a second list;
   in response to the block size is included in the second list, selecting a neural network model for the block size and performing downsampling on the block based on the block size and the neural network model; and
   performing a neural network-based intra prediction (NNIP) on the block using the neural network model; and
signaling a bitstream that is generated based on the encoding.
54. The method according to clause 53, wherein before performing downsampling on the block based on the block size, the encoding further comprises:
   performing transpose transformation on the block.
55. The method according to clause 53, wherein the first list comprises block sizes of {4×4, 8×4, 4×8, 16×4, 4×16, 32×4, 4×32, 8×8, 16×8, 8×16, 32×8, 8×32, 16×16, 32×16, 16×32, 32×32, 64×64}.
56. The method according to clause 55, wherein the second list comprises block sizes of {64×8, 8×64, 64×16, 16×64, 64×32, 32×64}.
57. The method according to clause 56, wherein the neural network model is selected from a 16×4 neural network model, a 16×8 neural network model, and a 16×16 neural network model.
58. The method according to clause 53, wherein selecting the neural network model comprises selecting the neural network model based on at least one of: a width-to-height ratio of the block; a downsampling factor along a width direction or a height direction; or whether transpose transformation is performed prior to downsampling.
59. A method for decoding a bitstream, the method comprising:
receiving a bitstream; and
decoding the bitstream to generate a video sequence, the decoding comprising:
   decoding a flag indicating whether to apply a neural network-based intra prediction (NNIP) fusion mode; and
   in response to the flag indicating the NNIP fusion mode is applied, fusing the NNIP mode with a first prediction mode, wherein the first prediction mode is different from the NNIP mode; and
   predicting a current block using the NNIP fusion mode.
60. The method according to clause 59, wherein the first prediction mode comprises one of a decoder-side intra mode derivation (DIMD) mode, an occurrence-based intra coding (OBIC) mode, a template-based intra mode derivation (TIMD) mode, TIMD-Merge mode, or TIMD-sum of absolute difference (SAD) mode.
61. The method according to clause 60, wherein fusing the NNIP mode with the first prediction mode further comprises:
   fusing a predictor of the NNIP mode with a predictor of the first prediction mode to generate a final predictor; and
predicting the current block using the NNIP fusion mode comprises:
   predicting the current block using the final predictor.
62. The method according to clause 61, wherein the final predictor is obtained by weighted sum of the predictor of the NNIP mode and the predictor of the first prediction mode.
63. The method according to clause 62, wherein a weight for the weighted sum is determined based template matching (TM) costs of the NNIP mode and the first prediction mode.
64. The method according to clause 62, wherein a weigh for the weighted sum is one of {1/8, 2/8, 3/8, 4/8, 5/8, 6/8, 7/8}; one of {1/16, 2/16, 3/16, 4/16, 5/16, 6/16, 7/16, 8/16, 9/16, 10/16, 11/16, 12/16, 13/16, 14/16, 15/16}; or 4/8.
65. The method according to clause 62, wherein the first predictor mode is the OBIC mode, and fusing the NNIP mode with the prediction mode further comprises:
   calculating sample-wise occurrence of the NNIP mode; and
   in response to the NNIP mode being included in top N highest occurrence modes, obtaining the final predictor by weighted sum of the predictor of the NNIP mode and the predictor of the OBIC mode, wherein N is a positive integer.
66. The method according to clause 60, wherein fusing the NNIP mode with the first prediction mode further comprises:
replacing a mode used in the first prediction mode with the NNIP mode in a fusion process of the first prediction mode to generate a final predictor; and
predicting the current block using the NNIP fusion mode comprises:
   predicting the current block using the final predictor.
67. The method according to clause 66, wherein the first prediction mode is the DIMD mode, and a non-angular mode in the DIMD mode is replaced by the NNIP mode.
68. The method according to clause 67, wherein the non-angular mode is a planar mode.
69. The method according to clause 67, wherein the non-angular mode is a planar mode or a block vector-based mode.
70. The method according to clause 67, wherein a weight for the NNIP mode in the fusing process of the DIMD mode is fixed to be one of {1/16, 2/16, 3/16, 4/16, 5/16, 6/16, 7/16, 8/16, 9/16, 10/16, 11/16, 12/16, 13/16, 14/16, 15/16}.
71. The method according to clause 66, wherein the first prediction mode is the TIMID mode, and a non-angular mode in the TIMD mode is replaced by the NNIP mode.
72. The method according to clause 71, wherein the non-angular mode is a planar mode.
73. The method according to clause 72, wherein a weight for the NNIP mode in the fusing process of the TIMD mode is fixed to be one of {1/16, 2/16, 3/16, 4/16, 5/16, 6/16, 7/16, 8/16, 9/16, 10/16, 11/16, 12/16, 13/16, 14/16, 15/16}.
74. The method according to clause 60, wherein the first prediction mode is the TIMID mode, and fusing the NNIP mode with the first prediction mode further comprises:
fusing the NNIP mode with angular modes in a fusion process of the TIMD mode to generate a final predictor; and
predicting the current block using the NNIP fusion mode comprises:
   predicting the current block using the final predictor.
75. A method for signaling a bitstream, the method comprising:
receiving a video sequence;
encoding the video sequence by:
   encoding a flag indicating whether to apply a neural network-based intra prediction (NNIP) fusion mode; and
   in response to the flag indicating the NNIP fusion mode is applied, fusing the NNIP mode with a first prediction mode, wherein the first prediction mode is different from the NNIP mode; and
   predicting a current block using the NNIP fusion mode; and
signaling a bitstream that is generated based on the encoding.
76. The method according to clause 75, wherein the first prediction mode comprises one of a decoder-side intra mode derivation (DIMD) mode, an occurrence-based intra coding (OBIC) mode, a template-based intra mode derivation (TIMD) mode, TIMD-Merge mode, or TIMD-sum of absolute difference (SAD) mode.
77. The method according to clause 76, wherein fusing the NNIP mode with the first prediction mode further comprises:
   fusing a predictor of the NNIP mode with a predictor of the first prediction mode to generate a final predictor; and
predicting the current block using the NNIP fusion mode comprises:
   predicting the current block using the final predictor.
78. The method according to clause 77, wherein the final predictor is obtained by weighted sum of the predictor of the NNIP mode and the predictor of the first prediction mode.
79. The method according to clause 78, wherein a weight for the weighted sum is determined based template matching (TM) costs of the NNIP mode and the first prediction mode.
80. The method according to clause 78, wherein a weigh for the weighted sum is one of {1/8, 2/8, 3/8, 4/8, 5/8, 6/8, 7/8}; one of {1/16, 2/16, 3/16, 4/16, 5/16, 6/16, 7/16, 8/16, 9/16, 10/16, 11/16, 12/16, 13/16, 14/16, 15/16}; or 4/8.
81. The method according to clause 78, wherein the first predictor mode is the OBIC mode, and fusing the NNIP mode with the prediction mode further comprises:
   calculating sample-wise occurrence of the NNIP mode; and
   in response to the NNIP mode being included in top N highest occurrence modes, obtaining the final predictor by weighted sum of the predictor of the NNIP mode and the predictor of the OBIC mode, wherein N is a positive integer.
82. The method according to clause 76, wherein fusing the NNIP mode with the first prediction mode further comprises:
replacing a mode used in the first prediction mode with the NNIP mode in a fusion process of the first prediction mode to generate a final predictor; and
predicting the current block using the NNIP fusion mode comprises:
   predicting the current block using the final predictor.
83. The method according to clause 82, wherein the first prediction mode is the DIMD mode, and a non-angular mode in the DIMD mode is replaced by the NNIP mode.
84. The method according to clause 83, wherein the non-angular mode is a planar mode.
85. The method according to clause 83, wherein the non-angular mode is a planar mode or a block vector-based mode.
86. The method according to clause 83, wherein a weight for the NNIP mode in the fusing process of the DIMD mode is fixed to be one of {1/16, 2/16, 3/16, 4/16, 5/16, 6/16, 7/16, 8/16, 9/16, 10/16, 11/16, 12/16, 13/16, 14/16, 15/16}.
87. The method according to clause 82, wherein the first prediction mode is the TIMID mode, and a non-angular mode in the TIMD mode is replaced by the NNIP mode.
88. The method according to clause 87, wherein the non-angular mode is a planar mode.
89. The method according to clause 88, wherein a weight for the NNIP mode in the fusing process of the TIMD mode is fixed to be one of {1/16, 2/16, 3/16, 4/16, 5/16, 6/16, 7/16, 8/16, 9/16, 10/16, 11/16, 12/16, 13/16, 14/16, 15/16}.
90. The method according to clause 76, wherein the first prediction mode is the TIMID mode, and fusing the NNIP mode with the first prediction mode further comprises:
fusing the NNIP mode with angular modes in a fusion process of the TIMD mode to generate a final predictor; and
predicting the current block using the NNIP fusion mode comprises:
   predicting the current block using the final predictor.
91. A method for decoding a bitstream, the method comprising:
receiving a bitstream; and
decoding the bitstream to generate a video sequence, the decoding comprising:
   adding a neural network-based intra prediction (NNIP) candidate into a candidate list of a first prediction mode to obtain an extended candidate list, wherein the first prediction mode is different from a NNIP mode; and
   predicting a current block based on the extended candidate list.
92. The method according to clause 91, wherein the first prediction mode is a geometric partition mode (GPM) with inter and intra mode or a spatial geometric partition mode (SGPM).
93. The method according to clause 92, wherein the first prediction mode is the GPM with inter and intra mode, and adding the NNIP candidate into a candidate list of a first prediction mode to obtain the extended candidate list further comprises at least one of:
   adding the NNIP candidate into an intra prediction mode (IPM) candidates list, and setting a value of a maximum intra mode index to be 4;
   replacing one IPM candidate in an IPM candidates list with the NNIP candidate; or
   inserting the NNIP candidate into an IPM candidates list, and obtaining a final IPM candidates list with first three candidates in the IPM candidate list.
94. The method according to clause 92, wherein the first prediction mode is the GPM with inter and intra mode or the SGPM, and a template-based split mode reordering is performed on the first prediction mode, the decoding further comprises:
   performing a template prediction for the NNIP candidate.
95. The method according to clause 94, wherein performing the template prediction for the NNIP candidate further comprises:
   performing a neural network-based prediction on a template for the NNIP candidate.
96. The method according to clause 95, wherein performing the neural network-based prediction on the template for the NNIP candidate further comprises:
   fetching reference samples of the template as a neural network's input to generate a template prediction result for the NNIP candidate.
97. The method according to clause 94, wherein performing the template prediction for the NNIP candidate further comprises:
   using a prediction result of the current block to approximate a template prediction result for the NNIP candidate.
98. The method according to clause 94, wherein performing the template prediction for the NNIP candidate further comprises:
   deriving an intra mode by performing a decoder-side intra mode derivation (DIMD) mode process on samples predicted using the NNIP mode; and
   performing the template prediction for the NNIP candidate using the intra mode.
99. The method according to clause 94, wherein performing the template prediction for the NNIP candidate further comprises:
   performing the template prediction using a planar mode.
100. The method according to clause 93, wherein the first prediction mode is a GPM with inter and intra prediction mode or the SGPM, and a regression-based extension is performed on the first prediction mode, adding the NNIP candidate into a candidate list of a first prediction mode to obtain the extended candidate list further comprises:
   inserting the NNIP candidate into an IPM candidate list.
101. The method according to clause 100, wherein the decoding further comprises:
   increasing a total index number by 1.
102. The method according to clause 93, wherein the first prediction mode is the SGPM, and adding the NNIP candidate into a candidate list of a first prediction mode to obtain the extended candidate list further comprises:
   adding the NNIP candidate, three IPM candidates, and 6 block vector-base candidates to obtain the extend candidate list.
103. A method for signaling a bitstream, the method comprising:
receiving a video sequence;
encoding the video sequence by:
   adding a neural network-based intra prediction (NNIP) candidate into a candidate list of a first prediction mode to obtain an extended candidate list, wherein the first prediction mode is different from a NNIP mode; and
   predicting a current block based on the extended candidate list; and
signaling a bitstream that is generated based on the encoding.
104. The method according to clause 103, wherein the first prediction mode is a geometric partition mode (GPM) with inter and intra mode or a spatial geometric partition mode (SGPM).
105. The method according to clause 104, wherein the first prediction mode is the GPM with inter and intra mode, and adding the NNIP candidate into a candidate list of a first prediction mode to obtain the extended candidate list further comprises at least one of:
   adding the NNIP candidate into an intra prediction mode (IPM) candidates list, and setting a value of a maximum intra mode index to be 4;
   replacing one IPM candidate in an IPM candidates list with the NNIP candidate; or
   inserting the NNIP candidate into an IPM candidates list, and obtaining a final IPM candidates list with first three candidates in the IPM candidate list.
106. The method according to clause 104, wherein the first prediction mode is the GPM with inter and intra mode or the SGPM, and a template-based split mode reordering is performed on the first prediction mode, the encoding further comprises:
   performing a template prediction for the NNIP candidate.
107. The method according to clause 106, wherein performing the template prediction for the NNIP candidate further comprises:
   performing a neural network-based prediction on a template for the NNIP candidate.
108. The method according to clause 107, wherein performing the neural network-based prediction on the template for the NNIP candidate further comprises:
   fetching reference samples of the template as a neural network's input to generate a template prediction result for the NNIP candidate.
109. The method according to clause 106, wherein performing the template prediction for the NNIP candidate further comprises:
   using a prediction result of the current block to approximate a template prediction result for the NNIP candidate.
110. The method according to clause 106, wherein performing the template prediction for the NNIP candidate further comprises:
   deriving an intra mode by performing a decoder-side intra mode derivation (DIMD) mode process on samples predicted using the NNIP mode; and
   performing the template prediction for the NNIP candidate using the intra mode.
111. The method according to clause 106, wherein performing the template prediction for the NNIP candidate further comprises:
   performing the template prediction using a planar mode.
112. The method according to clause 103, wherein the first prediction mode is a GPM with inter and intra prediction mode or the SGPM, and a regression-based extension is performed on the first prediction mode, adding the NNIP candidate into a candidate list of a first prediction mode to obtain the extended candidate list further comprises:
   inserting the NNIP candidate into an IPM candidate list.
113. The method according to clause 112, wherein the encoding further comprises: increasing a total index number by 1.
114. The method according to clause 104, wherein the first prediction mode is the SGPM, and adding the NNIP candidate into a candidate list of a first prediction mode to obtain the extended candidate list further comprises:
   adding the NNIP candidate, three IPM candidates, and 6 block vector-base candidates to obtain the extend candidate list.
115. A method for decoding a bitstream, the method comprising:
receiving a bitstream; and
decoding the bitstream to generate a video sequence, the decoding comprising:
   obtaining an intra predictor by a neural network-based intra prediction (NNIP) mode;
   obtaining a final predictor of a combined inter and intra prediction (CIIP) mode based on the intra predictor and an inter predictor; and
   predicting a current block using the final predictor.
116. The method according to clause 115, wherein the inter predictor is obtained by one of a regular merge mode, an affine merge mode, a subblock-based temporal motion vector prediction (SbTMVP) mode, or a template matching (TM) merge mode.
117. The method according to clause 115, wherein the decoding further comprises:
   determining whether the inter predictor being obtained by a first prediction mode;
   in response to the inter predictor being obtained by the first prediction mode, obtaining the intra predictor by the NNIP mode; wherein the first prediction mode is one of a regular merge mode, an affine merge mode, a subblock-based temporal motion vector prediction (SbTMVP) mode, or a template matching (TM) merge mode.
118. The method according to clause 115, wherein the decoding further comprises:
   determining whether the inter predictor being obtained by a first prediction mode or a second prediction mode;
   in response to the inter predictor being obtained by the first prediction mode or the second prediction mode, obtaining the intra predictor by the NNIP mode; wherein the first prediction mode and the second prediction mode are any two of a regular merge mode, an affine merge mode, a subblock-based temporal motion vector prediction (SbTMVP) mode, or a template matching (TM) merge mode.
119. The method according to clause 115, wherein the decoding further comprises:
   determining whether the inter predictor being obtained by a first prediction mode, a second prediction mode, or a third prediction mode;
   in response to the inter predictor being obtained by the first prediction mode, the second prediction mode, or the third prediction mode, obtaining the intra predictor by the NNIP mode; wherein the first prediction mode, the second prediction mode, and the third prediction mode are any three of a regular merge mode, an affine merge mode, a subblock-based temporal motion vector prediction (SbTMVP) mode, or a template matching (TM) merge mode.
120. A method for signaling a bitstream, the method comprising:
receiving a video sequence;
encoding the video sequence by:
   obtaining an intra predictor by a neural network-based intra prediction (NNIP) mode;
   obtaining a final predictor of a combined inter and intra prediction (CIIP) mode based on the intra predictor and an inter predictor; and
   predicting a current block using the final predictor; and
signaling a bitstream that is generated based on the encoding.
121. The method according to clause 120, wherein the inter predictor is obtained by one of a regular merge mode, an affine merge mode, a subblock-based temporal motion vector prediction (SbTMVP) mode, or a template matching (TM) merge mode.
122. The method according to clause 120, wherein the encoding further comprises:
   determining whether the inter predictor being obtained by a first prediction mode;
   in response to the inter predictor being obtained by the first prediction mode, obtaining the intra predictor by the NNIP mode; wherein the first prediction mode is one of a regular merge mode, an affine merge mode, a subblock-based temporal motion vector prediction (SbTMVP) mode, or a template matching (TM) merge mode.
123. The method according to clause 120, wherein the encoding further comprises:
   determining whether the inter predictor being obtained by a first prediction mode or a second prediction mode;
   in response to the inter predictor being obtained by the first prediction mode or the second prediction mode, obtaining the intra predictor by the NNIP mode; wherein the first prediction mode and the second prediction mode are any two of a regular merge mode, an affine merge mode, a subblock-based temporal motion vector prediction (SbTMVP) mode, or a template matching (TM) merge mode.
124. The method according to clause 120, wherein the encoding further comprises:
   determining whether the inter predictor being obtained by a first prediction mode, a second prediction mode, or a third prediction mode;
   in response to the inter predictor being obtained by the first prediction mode, the second prediction mode, or the third prediction mode, obtaining the intra predictor by the NNIP mode; wherein the first prediction mode, the second prediction mode, and the third prediction mode are any three of a regular merge mode, an affine merge mode, a subblock-based temporal motion vector prediction (SbTMVP) mode, or a template matching (TM) merge mode.
125. A method for decoding a bitstream, the method comprising:
receiving a bitstream; and
decoding the bitstream to generate a video sequence, the decoding comprising:
   determining an angular-wise weight for a combined inter and intra prediction (CIIP) mode;
   obtaining a final predictor of the CIIP mode based on the angular-wise weight; and
   predicting a current block using the final predictor.
126. The method according to clause 125, wherein determining the angular-wise weight for the CIIP mode further comprises:
   determining a prediction direction of an intra prediction mode of the CIIP mode;
   classifying the intra prediction mode into a category based on the prediction direction; and
   determining the angular-wise weight based on the category.
127. The method according to clause 125, wherein classifying the intra prediction mode into a category based on the prediction direction further comprises:
classifying the intra prediction mode into one category of three categories based on the prediction direction and a block size, wherein the three categories comprise near horizontal modes, near vertical modes, and near diagonal modes.
128. The method according to clause 127, wherein the angular-wise weight is a pixel level weight.
129. The method according to clause 125, wherein the decoding further comprises:
   determining an inter prediction mode for an inter predictor of the CIP mode; and
   in response to the inter prediction mode is not an affine merge mode or a subblock-based temporal motion vector prediction (SbTMVP) mode, determining the angular-wise weight for the CIP mode.
130. The method according to clause 126, wherein a neural network-based intra prediction (NNIP) mode is applied for an intra prediction, and the intra prediction mode is an equivalent angular mode of the NNIP mode.
131. A method for signaling a bitstream, the method comprising:
receiving a video sequence;
encoding the video sequence by:
   determining an angular-wise weight for a combined inter and intra prediction (CIIP) mode;
   obtaining a final predictor of the CIIP mode based on the angular-wise weight; and
   predicting a current block using the final predictor; and
signaling a bitstream that is generated based on the encoding.
132. The method according to clause 131, wherein determining the angular-wise weight for the CIIP mode further comprises:
   determining a prediction direction of an intra prediction mode of the CIIP mode;
   classifying the intra prediction mode into a category based on the prediction direction; and
   determining the angular-wise weight based on the category.
133. The method according to clause 131, wherein classifying the intra prediction mode into a category based on the prediction direction further comprises:
classifying the intra prediction mode into one category of three categories based on the prediction direction and a block size, wherein the three categories comprise near horizontal modes, near vertical modes, and near diagonal modes.
134. The method according to clause 133, wherein the angular-wise weight is a pixel level weight.
135. The method according to clause 131, wherein the encoding further comprises:
   determining an inter prediction mode for an inter predictor of the CIP mode; and
   in response to the inter prediction mode is not an affine merge mode or a subblock-based temporal motion vector prediction (SbTMVP) mode, determining the angular-wise weight for the CIP mode.
136. The method according to clause 132, wherein a neural network-based intra prediction (NNIP) mode is applied for an intra prediction, and the intra prediction mode is an equivalent angular mode of the NNIP mode.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for encoding a video sequence, the method comprising:
receiving a video sequence; and
encoding the video sequence by:
determining a block size of a block;
determining whether the block size is included in a first list;
in response to the block size is not included in the first list, determining whether the block size is included in a second list;
in response to the block size is included in the second list, selecting a neural network model for the block size and performing downsampling on the block based on the block size and the neural network model; and
performing a neural network-based intra prediction (NNIP) on the block using the neural network model.

2. The method according to claim 1, wherein before performing downsampling on the block based on the block size, the encoding further comprises:
performing transpose transformation on the block.

3. The method according to claim 1, wherein the first list comprises block sizes of {4×4, 8×4, 4×8, 16×4, 4×16, 32×4, 4×32, 8×8, 16×8, 8×16, 32×8, 8×32, 16×16, 32×16, 16×32, 32×32, 64×64}.

4. The method according to claim 3, wherein the second list comprises block sizes of {64×8, 8×64, 64×16, 16×64, 64×32, 32×64}.

5. The method according to claim 4, wherein the neural network model is selected from a 16×4 neural network model, a 16×8 neural network model, and a 16×16 neural network model.

6. The method according to claim 1, wherein selecting the neural network model comprises selecting the neural network model based on at least one of: a width-to-height ratio of the block; a downsampling factor along a width direction or a height direction; or whether transpose transformation is performed prior to downsampling.

7. The method according to claim 1, further comprising:
storing a bitstream that is generated based on the encoding.

8. A method for decoding a bitstream, the method comprising:
receiving a bitstream; and
decoding the bitstream to generate a video sequence, the decoding comprising:
determining a block size of a block;
determining whether the block size is included in a first list;
in response to the block size is not included in the first list, determining whether the block size is included in a second list;
in response to the block size is included in the second list, selecting a neural network model for the block size and performing downsampling on the block based on the block size and the neural network model; and
performing a neural network-based intra prediction (NNIP) on the block using the neural network model.

9. The method according to claim 8, wherein before performing downsampling on the block based on the block size, the decoding further comprises:
performing transpose transformation on the block.

10. The method according to claim 8, wherein the first list comprises block sizes of {4×4, 8×4, 4×8, 16×4, 4×16, 32×4, 4×32, 8×8, 16×8, 8×16, 32×8, 8×32, 16×16, 32×16, 16×32, 32×32, 64×64}.

11. The method according to claim 10, wherein the second list comprises block sizes of {64×8, 8×64, 64×16, 16×64, 64×32, 32×64}.

12. The method according to claim 11, wherein the neural network model is selected from a 16×4 neural network model, a 16×8 neural network model, and a 16×16 neural network model.

13. The method according to claim 8, wherein selecting the neural network model comprises selecting the neural network model based on at least one of: a width-to-height ratio of the block; a downsampling factor along a width direction or a height direction; or whether transpose transformation is performed prior to downsampling.

14. A method for signaling a bitstream, the method comprising:
receiving a video sequence;
encoding the video sequence by:
determining a block size of a block;
determining whether the block size is included in a first list;
in response to the block size is not included in the first list, determining whether the block size is included in a second list;
in response to the block size is included in the second list, selecting a neural network model for the block size and performing downsampling on the block based on the block size and the neural network model; and
performing a neural network-based intra prediction (NNIP) on the block using the neural network model; and
signaling a bitstream that is generated based on the encoding.

15. The method according to claim 14, wherein before performing downsampling on the block based on the block size, the encoding further comprises:
performing transpose transformation on the block.

16. The method according to claim 14, wherein the first list comprises block sizes of {4×4, 8×4, 4×8, 16×4, 4×16, 32×4, 4×32, 8×8, 16×8, 8×16, 32×8, 8×32, 16×16, 32×16, 16×32, 32×32, 64×64}.

17. The method according to claim 16, wherein the second list comprises block sizes of {64×8, 8×64, 64×16, 16×64, 64×32, 32×64}.

18. The method according to claim 17, wherein the neural network model is selected from a 16×4 neural network model, a 16×8 neural network model, and a 16×16 neural network model.

19. The method according to claim 14, wherein selecting the neural network model comprises selecting the neural network model based on at least one of: a width-to-height ratio of the block; a downsampling factor along a width direction or a height direction; or whether transpose transformation is performed prior to downsampling.
